(19) United States
(12) Patent Application Publication
(10) Pub. No.: US 2024/0058742 A1
(43) Pub. Date: Feb. 22, 2024

(54) SYSTEM AND METHOD OF REGULATING A TEMPERATURE OF A CO2 CAPTURE VESSEL DURING THERMAL SWING ADSORPTION USING AN INTER-EXCHANGER

(71) Applicant: Enhanced Energy Group LLC, West Kingston, RI (US)

(72) Inventor: Paul M. DUNN, West Kingston, RI (US)

(73) Assignee: Enhanced Energy Group LLC, West Kingston, RI (US)

(21) Appl. No.: 18/361,208

(22) Filed: Jul. 28, 2023

Related U.S. Application Data
(60) Provisional application No. 63/371,899, filed on Aug. 19, 2022.

(51) Int. Cl. B01D 53/04; B01D 53/26

(52) U.S. Cl. CPC B01D 53/0462; B01D 53/261; B01D 2257/504; B01D 2256/10; B01D 2259/652; B01D 2253/102

(57) ABSTRACT

A capture vessel is provided that is configured to capture carbon dioxide (CO₂) according to a thermal swing adsorption (TSA) process. The TSA process includes a cyclical sequence including at least a CO₂ capture stage, a regeneration stage, and a cooling stage. The capture vessel includes capture media arranged inside the capture vessel, and an inter-exchanger arranged inside the capture vessel and thermally coupled to the capture media. The capture media are configured to adsorb CO₂ from an exhaust gas during the CO₂ capture stage to produce a nitrogen (N₂) gas that exits the capture vessel. The inter-exchanger is configured to, during the CO₂ capture stage, circulate a coolant within the capture vessel to regulate a temperature of the capture media.

### CROSS-REFERENCE TO RELATED APPLICATION

This patent application claims priority to U.S. Provisional Patent Application No. 63/371,899, filed on Aug. 19, 2022. The disclosure of the prior application is considered part of and is incorporated by reference into this patent application.

### TECHNICAL FIELD

The present disclosure relates generally to carbon capture and thermal swing adsorption (TSA) processes for carbon capture.

### BACKGROUND

Molecular (mole) sieves include synthetic media (e.g., ceramic-like media), available in various physical sizes (powder to ¼ inch round). Based on a composition and crystal structure of the synthetic media, mole sieves are capable of adsorbing, or not adsorbing, particular species of molecule based mostly on a size of the molecule. For example, a 3 A sieve will adsorb water (H₂O), ammonia (NH3), and little else. Molecules like CO₂, O₂, N₂, and argon would pass through the 3 A sieve. The 3 A sieve (and alumina) are typically used in dehydration processes. A 5 A sieve will adsorb all of the species of the 3 A but will also adsorb CO₂ and most pollutants (CO, HC, NOx) while allowing O₂, N₂, and argon to pass through the 5 A sieve. A 13X sieve captures larger molecules, including many hydrocarbons, but still allows O₂, N₂, and argon to pass through the 13X sieve. When a mole sieve is cold and a partial pressure of a desired species is high, the mole sieve will adsorb the desired species. The mole sieve will release the desired species when a temperature is increased, and/or the partial pressure is lowered. Hence, the terms pressure swing, thermal swing, vacuum swing, or combinations of the swing processes are used to describe the capture and release of the desired species by the mole sieve. However, the swing processes are inefficient in terms of electrical power required to perform the swing processes to sufficiently capture and release CO₂, which increases costs.

Activated carbon behaves similarly to mole sieves, and can be used in lieu of mole sieves in some cases. However, activated carbon has a different affinity for compounds that is not based on molecule size. Using activated carbon is higher in cost and lower in performance in terms of CO₂ capture compared with mole sieves, but has advantages of a lower heat of adsorption for water (e.g., about 1000 BTU/lb for activated carbon vs. about 1800 BTU/lb for mole sieves) and a lower heat of adsorption for CO₂.

The carbon capture system of the present disclosure solves one or more of the problems set forth above and/or other problems in the field.

### SUMMARY

In some implementations, a carbon capture system for carbon dioxide (CO₂)-thermal swing adsorption (TSA) includes an exhaust source configured to produce a hot exhaust; an adsorption inlet arranged downstream from the exhaust source and configured to receive a cold exhaust comprising a mixture of CO₂ and nitrogen (N₂), wherein the cold exhaust is derived from the hot exhaust using one or more first heat exchangers; and a plurality of capture vessels that are configured to be respectively cycled through a plurality of stages of a CO₂-TSA process, including a CO₂ capture stage, a regeneration stage, and a cooling stage, wherein the plurality of capture vessels are respectively coupled to the adsorption inlet for receiving the cold exhaust during the CO₂ capture stage, wherein each capture vessel of the plurality of capture vessels includes a respective inter-exchanger, and wherein each respective inter-exchanger is configured to circulate a respective coolant within a respective capture vessel during a respective CO₂ capture stage of the respective capture vessel in order to cool at least a portion of capture media of the respective capture vessel during the respective CO₂ capture stage.

In some implementations, a capture vessel configured to capture carbon dioxide (CO₂) according to a thermal swing adsorption (TSA) process includes capture media arranged inside the capture vessel; and an inter-exchanger arranged inside the capture vessel and thermally coupled to the capture media, and wherein the capture media are configured to adsorb CO₂ from an exhaust gas during the CO₂ capture stage to produce a nitrogen (N₂) gas that exits the capture vessel, wherein the inter-exchanger is configured to, during the CO₂ capture stage, circulate a coolant within the capture vessel to regulate a temperature of the capture media.

### BRIEF DESCRIPTION OF THE DRAWINGS

FIG. 1 illustrates a carbon capture system according to one or more implementations.

FIG. 2 shows an example cycle timing diagram of a CO₂-TSA process using three capture vessels and a plurality of valves for a batch sequence.

FIG. 3 shows an example diagram showing flow directions of fluid flow and a process sequence in a capture vessel.

FIG. 4 illustrates a carbon capture system according to one or more implementations.

FIG. 5 shows a cross-section of a capture vessel according to one or more embodiments.

FIGS. 6A-6E illustrates a carbon capture system according to one or more implementations.

FIG. 7 illustrates a carbon capture system according to one or more implementations.

FIG. 8 shows a four-stage process flow of a CO₂-TSA process in a capture vessel according to one or more implementations.

FIG. 9 shows a structure of a CO₂ evaporative cooler according to one or more implementations.

### DETAILED DESCRIPTION

This disclosure relates to carbon capture, which is applicable to any machine, system, or plant that uses a combustion engine, such as a piston engine or a turbine engine. For example, the disclosure relates to a CO₂ thermal swing adsorption (TSA) process with improved performance using CO₂ and a CO₂-turbocharger to drive the thermal swing adsorption process with reduced or zero electrical power. Carbon capture systems and methods of carbon capture are provided, which are applicable in general to distributed power applications in a 1-40 megawatt (MW) range, which uses a CO₂-TSA process, designed with a semi-closed cycle (SCC), but also applicable to other raw CO₂ sources. The carbon capture systems and methods use exhaust waste heat as part of the CO₂-TSA process, and use thermal sinks and mixed water vapor and dry gas for improved CO₂ capture.

The carbon capture systems and methods may provide as least one of the following benefits, including: (1) lower the cost of carbon capture in small distributed applications, generally between 1 and 40 MW per engine, targeting CO₂ associated with semi-closed cycle techniques (e.g., a process that uses a combination of cooled exhaust recirculation and oxygen augmentation for reciprocating piston engines and/or gas turbine engines), but also applicable to other sources; (2) enable a use of high performance molecular sieves, in a TSA process, in a manner which does not dilute a purity of or reduce a capture efficiency of the CO₂; (3) substantially reduce electrical and/or mechanical loads associated with the carbon capture; (4) improve a construction of TSA vessels to lower the cost of carbon capture and to minimize performance issues associated with leakage; (5) mitigate other pollutants, such as NOx, Sox, CO, HC; and (6) provide a solution suitable for new construction or retrofit application at lower cost.

The carbon capture systems and methods target dilute CO₂ streams (3-11% CO₂-content) that exist in distributed power to gas turbines, lean burn piston engines (spark or compression ignited), and rich burn piston engines, with or without exhaust concentration of the SCC. The carbon capture systems and methods may improve regeneration performance in CO₂-TSA, reducing a time for regeneration and improving a percentage of carbon captured. The improved regeneration performance in CO₂-TSA may be accomplished via a use of a water vapor and CO₂ mixture to provide both heat and a purge/displacement effect, which are created in a unique way. Additionally, some implementations, may include an N₂-turbo component to improve dehydration. A management of temperatures at a machinery inlet (e.g., at the CO₂-turbocharger) may also be improved and new methods to reduce NOₓ and SOₓ are disclosed. Finally, adsorption performance may be improved via improved cooling.

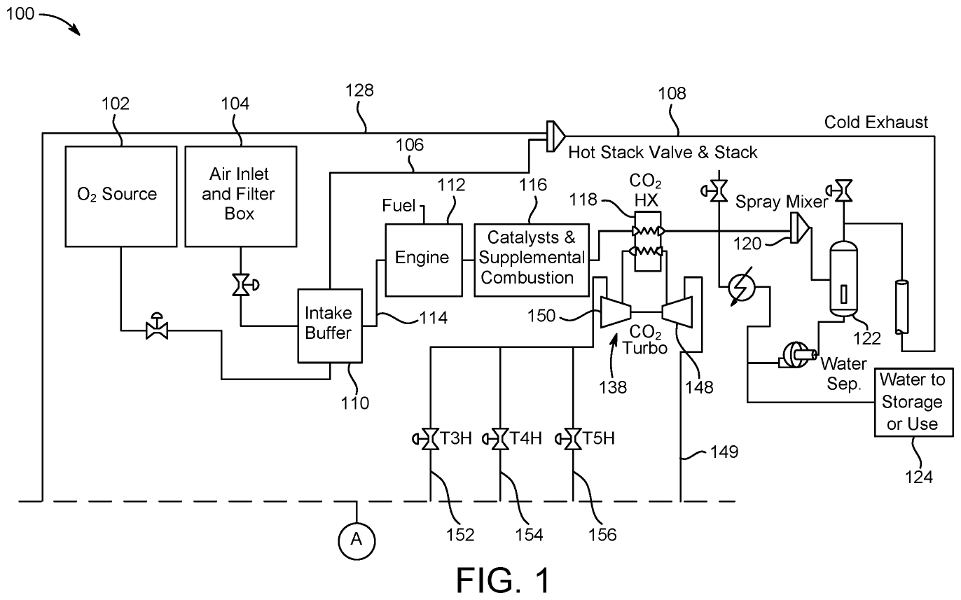

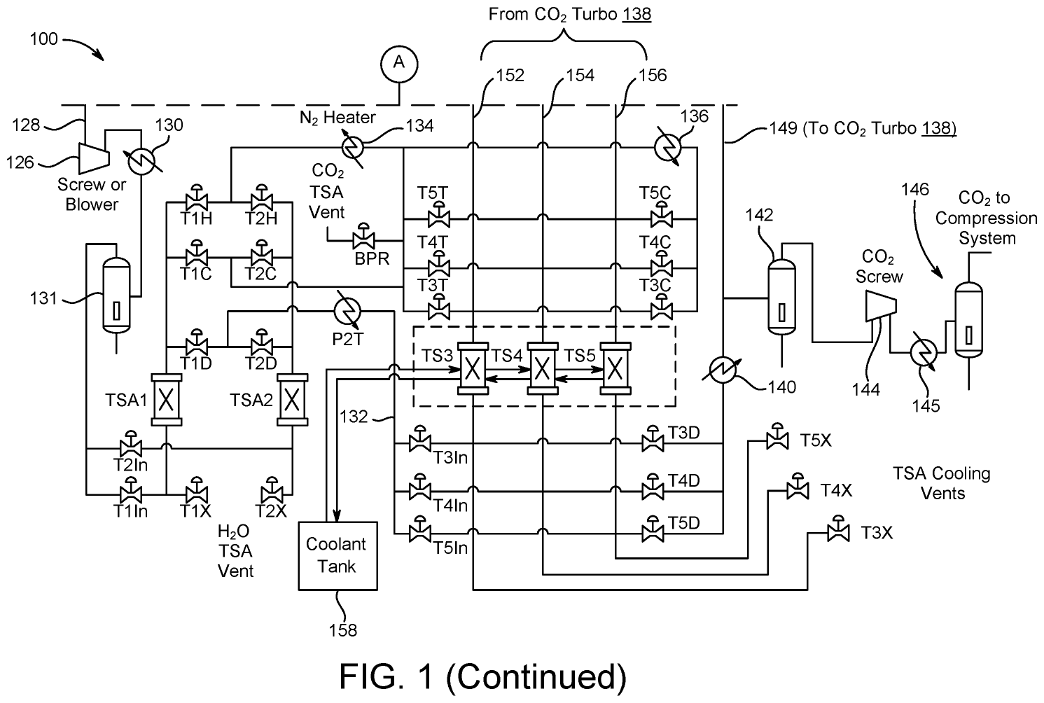

FIG. 1 illustrates a carbon capture system 100 according to one or more implementations. The carbon capture system 100 includes components for a CO₂-TSA processes with a semi-closed cycle. The components may be interconnected by a plurality of manifolds that may be configured to carry one or more fluids (e.g., liquids, gases, or gas-liquid mixtures).

The carbon capture system 100 may include an O₂ source 102 (e.g., an O₂ plant) that provides O₂, an air inlet and filter box 104 that provides air, an SCC path 106 that is used to provide a portion of cooled exhaust from an exhaust return path 108, an intake buffer tank 110, and an engine 112. As is the case with any combustion engine, fuel is combusted, and that combustion requires an oxidizer, which is generally air. The engine 112 (e.g., a turbine engine, piston engine) may draw in a working fluid 114 from the intake buffer tank 110. In some implementations, the engine 112 may be another type of exhaust source. The working fluid 114 used as an artificial atmosphere may be a mixture of air, oxygen, and cooled exhaust. A mixed concentration of oxygen in the intake buffer tank is a variable, but generally falls in the range of 12-22% O₂. The engine 112 combusts the fuel in the artificial atmosphere to produce a hot exhaust (e.g., a hot flue gas). The hot exhaust may flow through optional catalysts and supplemental combustion (block 116) to an exhaust heat exchanger (e.g., CO₂ heat exchanger (CO₂ HX) 118 or chiller 615). The exhaust heat exchanger partially cools the hot exhaust (e.g., to about 400° F.). The partially cooled exhaust is then mixed with colder water by a spray mixer 120, which quenches the partially cooled exhaust down to about 100° F. As a result, most of the water from combustion products in the exhaust condenses, and the condensed water is removed in a gas-liquid separator 122 (e.g., a direct contact cooler (DCC)). The condensed water accumulates in a water storage tank 124 unless the condensed water is otherwise used or disposed of. For example, the condensed water may be used as make-up water in a cooling tower, eliminating or reducing a problem of water disposal.

The cooled exhaust (e.g., cold exhaust), now depleted of most of the water, returns to the intake buffer tank 110 via the SCC path 106 or to a TSA screw/blower 126 (fan) via a TSA path 128. The SCC path 106 is part of an SCC exhaust loop that starts at the intake buffer tank 110, proceeds through the gas-liquid separator 122 to the exhaust return path 108, and returns back through the SCC path to the intake buffer tank 110. The SCC is used to increase CO₂ concentration for an adsorption bed (e.g., for capture vessels TS3, TS4, and TS5) via exhaust recirculation.

A flowrate at the TSA screw/blower 126, which may be a variable speed drive or may include other methods of flow regulation, indirectly sets a level of exhaust recirculation, since an engine flowrate is essentially fixed. Thus, CO₂ that is not removed by the carbon capture system 100 may be recirculated, and a balance of the artificial atmosphere at the engine will be made up by air and/or oxygen.

Downstream of the TSA screw/blower 126 is a network of interconnected components that are responsible for performing the carbon capture via a CO₂-TSA process. Immediately downstream of the TSA screw/blower 126 is a heat exchanger/chiller 130, typically cooling the cold exhaust to 35-50° F., which will cause more water present in the cold exhaust to condense, reducing a load on molecular sieves that follow. A tank 131 may be connected immediately downstream from the heat exchanger/chiller 130 to separate the water from the cold exhaust.

Valves T1In, T2In, T1X, T2X, T1D, T2D, T1C, T2C, T1H, T2H, T3In, T4In, T5In, T3D, T4D, T5D, T3X, T4X, T5X, T3T, T4T, T5T, T3C, T4C, T5C, T3H, T4H, T5H, and BPR are used to control a flow of one or more fluids throughout the carbon capture system 100. An open state and a closed state of each of the valves may be controlled by a controller (not illustrated) according to one or more process stages of the CO₂-TSA process. For example, three capture vessels TS3, TS4, or TS5 may be arranged in parallel, and the valves may be controlled such that a process stage at each one of the three capture vessels TS3, TS4, or TS5 (e.g., CO₂ capture vessels) is controlled based on a batch sequence of the CO₂-TSA process. For example, the valves may be controlled such that the capture vessel TS3 is in an adsorption stage (e.g., a capture stage), while the capture vessel TS4 is in a cooling stage and the capture vessel TS4 is a regeneration stage. The valves may further be controlled such that the capture vessel TS4 in in an adsorption stage (e.g., a capture stage), while the capture vessel TSA5 is in a cooling stage and the capture vessel TSA3 is a regeneration stage. The valves may further be controlled such that the capture vessel TS5 in an adsorption stage (e.g., a capture stage), while the capture vessel TSA3 is in a cooling stage and the capture vessel TS4 is a regeneration stage. The batch sequence may then be repeated.

In some implementations, the capture vessels TS3, TS4, or TS5 may be referred to as “beds.” Each capture vessel TS3, TS4, and TS5 may include media (e.g., capture media) that is configured to capture or adsorb CO₂. In some cases, the media may also adsorb water.

A first step in the CO₂-TSA process is a water dehydration process carried out by a blend of alumina and a 3 A mole sieve in adsorbent vessels TSA1 and TSA2. The water dehydration process is a batch type process. Thus, when one adsorbent vessel TSA1 or TSA2 is adsorbing water, the other adsorbent vessel TSA1 or TSA2 is off-line, either being heated or being cooled. Valves TIM and T2In control which adsorbent vessel TSA1 or TSA2 is receiving the cold exhaust from the heat exchanger/chiller 130. For description purposes, assuming adsorbent vessel TSA1 is dehydrating, then valve TIM is open, and the cold exhaust flows through the adsorbent vessel TSA1 and out valve T1D, through another cooler P2T, to one of the capture vessels TS3, TS4, or TS5 for carbon capture. At an adsorption inlet 132 of the capture vessels TS3, TS4, and TS5, the cold exhaust has essentially zero water, and is typically composed of 5-20% CO₂, 0-10% O₂, and a balance inert mixture (e.g., nitrogen, with a little argon).

Assuming the capture vessel TS3 is at this point adsorbing CO₂, valve T3In will be open, with valves T4In and T5In closed. The exhaust gas, now depleted of CO₂ via the capture vessel TS3 and water via one of the adsorbent vessels TSA1 and TSA2, flows out of the capture vessel TS3 via valve T3T, which is open, while valves T4T and T5T are closed. The exhaust gas flowing out of the capture vessel TS3 is a relatively warm dry gas having a temperature around 80-160° F., and is composed mostly of N₂ gas. The exhaust gas flowing out of the capture vessel TS3 flows out of the capture vessel TS3 and through the valve T3T and may be manifolded to several locations. For simplicity, this relatively warm dry gas that flows out of the capture vessel performing CO₂ adsorption (e.g., capture vessel TS3) may be referred to as a dry N₂ gas or depleted flue gas.

If all downstream valves are closed, or if a backpressure for some reason is too high, any excess dry N₂ gas will be discharged to atmosphere via a CO₂ TSA vent, controlled by a back pressure regulator of the valve BPR. Generally, the backpressure is lower than a setpoint of the back pressure regulator and the valve BPR remains closed.

A portion of the dry N₂ gas may be used to heat either adsorbent vessel TSA1 or TSA2 (e.g., whichever adsorbent vessel is not adsorbing water, in this example adsorbent vessel TSA2), or to cool TSA2, depending on a cycle time. During a heating process of one of the adsorbent vessels TSA1 or TSA2, the dry N₂ gas may be directed through an N₂ heater 134 (e.g., a heat exchanger) by opening one of the valves T1H or T2H and closing both valves T1C and T2C. During a cooling process of one of the adsorbent vessels TSA1 or TSA2, the dry (warm) N₂ gas may be directed from the valve T3T to bypass the N₂ heater 134 by opening one of the valves T1C or T2C and closing both valves T1H and T2H.

For example, if a design point is 8 hours for water adsorption (dehydration) in the adsorbent vessel TSA1 and the adsorbent vessel TSA2, then the adsorbent vessel TSA1 would be set for adsorbing water for 8 hours, and, in parallel, the adsorbent vessel TSA2 would be first set for regeneration (heated) by opening valves T2H and T2X, using the heated dry N₂ from the N₂ heater 134, for about 4 hours, and then would be cooled, for about 4 hours, by opening valve T2C, while closing valve T2H with valve T2X still open. After 8 hours this process would reverse, with TSA2 taking over the adsorption (dehydration) duty, and with TSA1 being heated, then cooled, via combinations of valve actions at T1H, T1C, and T1X. The cycle time for water adsorption is typically several hours, generally between 3 and 12 hours.

After chilling and condensation, there is in most cases an order of magnitude more CO₂ in the exhaust than water in the exhaust, and the capacity for CO₂ per unit weight of mole sieve is lower than that of water. As a result, cycle times for CO₂ adsorption in the capture vessels TS3, TS4, and TS5 are measured in minutes, not hours. Assuming the capture vessel TS3 is adsorbing CO₂ (e.g., valves T3In and T3T are open), a portion of the dry N₂ gas that exits the capture vessel TS3 via valve T3T, optionally further cooled via a heat exchanger/chiller 136, can pass through valve T4C to provide cooling to the capture vessel TS4, and can exit via valve T4X. It is noted that the volume of gas required for cooling may not be met fully by the flow rate coming from the capture vessel TS3, and methods to augment the flow via recirculation or mitigate the amount of flow needed are described below.

After the CO₂ adsorption cycle is complete (e.g., in capture vessel TS3), the captured CO₂ must be released during the regeneration stage. In a TSA process, releasing captured CO₂ is done mostly via heating. In the present disclosure, that heating is provided by a hot gas mixture, which is mostly hot CO₂ in this example delivered via valve T3H to the capture vessel TS3. The hot CO₂ is generally at 600-800° F. The hot CO₂ gas flows downward from a CO₂-turbocharger 138, through valve T3H, and through the media in the capture vessel TS3, which gradually heats the media, and drives off more CO₂. Warm CO₂ exits the capture vessel TS3 and flows via valve T3D to a cooler 140 (e.g., a heat exchanger), and a portion of the CO₂ gas splits off, flowing through a separator 142 (in theory unneeded, this being dry gas, it is really there to add volume to improve control), to a CO₂ screw compressor 144, to a chiller 145 (e.g., a heat exchanger), a CO₂ storage tank 146, and downstream to the rest of the CO₂ compression or use systems. The flowrate at the CO₂ screw compressor 144, also generally variable speed, indirectly sets a pressure in the capture vessel TS3 during a desorption process of the regeneration stage.

A desorption flowrate required is much higher than a raw exhaust flowrate on both a mass and volume basis. In addition, given the higher temperature, a pressure drop through the capture vessel would also be higher, up to 10 psi, vs. 1-2 psi for adsorption, resulting in high electrical loads. In the present disclosure, the CO₂ gas produced during the desorption process is recirculated to support these higher flowrates, and more importantly, a powering for a recirculation of the CO₂ gas is performed by the CO₂-turbocharger 138.

Heat used to power the CO₂-turbocharger 138, and to heat a capture vessel TS3, TS4, or TS5 during the regeneration stage, comes from the exhaust of the engine 112. After passing through valve T3D and the cooler 140, a portion of the CO₂ gas released from the relevant capture vessel TS3, TS4, or TS5 (e.g., capture vessel TS3 in this example,) enters a turbocharger compressor 148 of the CO₂-turbocharger 138 via manifold 149, boosted in pressure (e.g., to 15-25 psi), raising the temperature of the CO₂ gas to 300° F. or more. In other words, the manifold 149 connects capture vessel TS3, TS4, and TS5 to the turbocharger compressor 148 of the CO₂-turbocharger 138 to transport a CO₂ stream of CO₂ gas generated by a capture vessel set in the regeneration stage to the turbocharger compressor 148.

The heated CO₂ gas from the turbocharger compressor 148 then enters the CO₂ heat exchanger (CO₂ HX) 118, and is heated to near raw exhaust temperature, typically 800-900° F., by a heat exchange process that uses the exhaust from the engine 112 for further heating the heated CO₂ gas to produce hot CO₂ gas. This hot CO₂ gas is then expanded through an expander 150 (e.g., a decompressor) of the CO₂-turbocharger 138 (which causes the temperature of the hot CO₂ to drop due to less pressure). However, due to the super-heating process performed by the turbocharger compressor 148 and the CO₂ heat exchanger (CO₂ HX) 118, the CO₂ gas exiting the expander 150 still has a temperature equal to or greater than 600° F. that is sufficient for the regeneration process, and still at a pressure high enough to support a flow through the capture vessel TS3, TS4, or TS5 that is performing the regeneration (e.g., capture vessel TS3 in this example). For example, a pressure increase on a compressor side of the CO₂-turbocharger 138 significantly exceeds a pressure decrease on an expander side of the CO₂-turbocharger 138, such that a pressure of the CO₂ gas exiting the expander 150 toward the capture vessel TS3, TS4, or TS5 is high enough to support the flow of the CO₂ gas through the capture vessel TS3, TS4, or TS5 that is performing the regeneration. The expander 150 may be respectively coupled to the capture vessels TS3, TS4, TS5 via manifolds 152, 154, and 156 to provide a heated CO₂ gas to a capture vessel that is set in the regeneration stage. At an end of the regeneration process, virtually no CO₂, and almost no water, remains in the capture vessel TS3, TS4, or TS5 that is performing the regeneration (e.g., the capture vessel TS3).

As a result of the regeneration process, the media (e.g., the mole sieve) of the capture vessel TS3, TS4, or TS5 is hot, typically with an average temperature of about 500° F., and must be cooled to prepare the capture vessel for a next CO₂ adsorption cycle. A cooling process for the capture vessel TS3 is accomplished by opening valves T3C and T3X, while closing valves T3In, T3T, T3H, and T3D. In other words, the dry (warm) N₂ gas that exits the capture vessel set in the adsorbing stage (e.g., capture vessel TS5 for cooling of capture vessel TS3) is directed into the capture vessel TS3 for cooling the media of the capture vessel TS3.

The cooling process need not return the media temperature fully to ambient temperature. Any temperature under 100° C. (212° F.) will provide some capacity for initial adsorption of CO₂, with temperatures near or below 50° C. (122° F.) being preferred. The cooling process may continue in parallel with the adsorption process to some extent since a raw exhaust stream from cooler P2T (e.g., a heat exchanger) is provided at nominally 10° C. (50° F.).

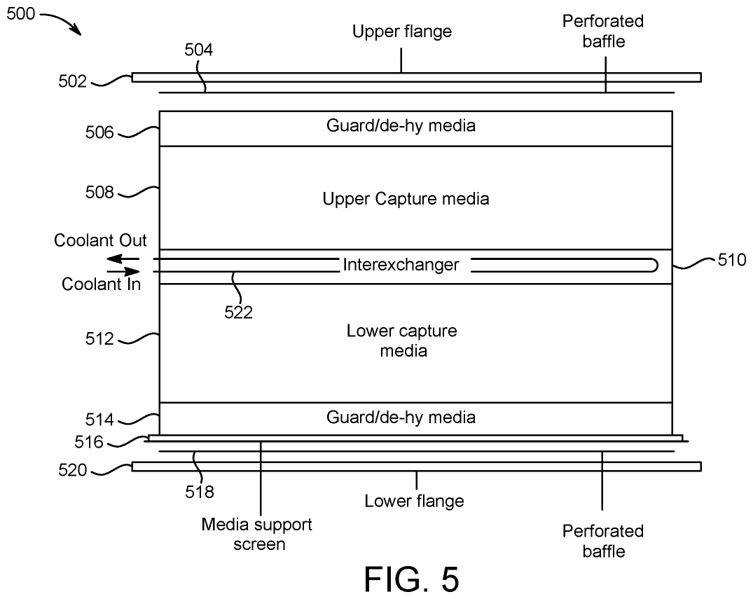

In addition, the carbon capture system 100 may include a coolant tank 158 or another coolant source or circulator that is configured to circulate coolant through a capture vessel (e.g., capture vessels TS3, TS4, or TS5) that is configured in an adsorption stage. The coolant may be circulated through a coil of an inter-exchanger of the capture vessel, as described further in connection with FIG. 5, while the capture vessel is performing CO₂ adsorption. In some implementations, the inter-exchanger may be used to circulate the coolant in the capture vessel during the cooling stage.

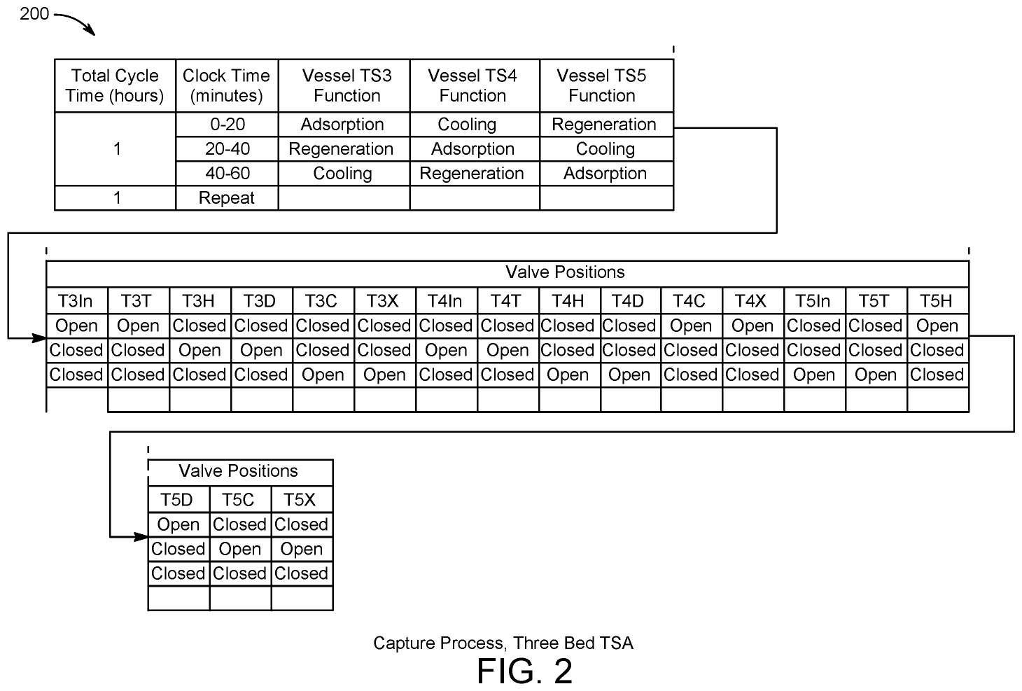

FIG. 2 shows an example cycle timing diagram 200 of the CO₂-TSA process using capture vessels TS3, TS4, and TS5, including a state of each of the valves during each stage, including the adsorption stage, the cooling stage, and the regeneration stage of the batch sequence.

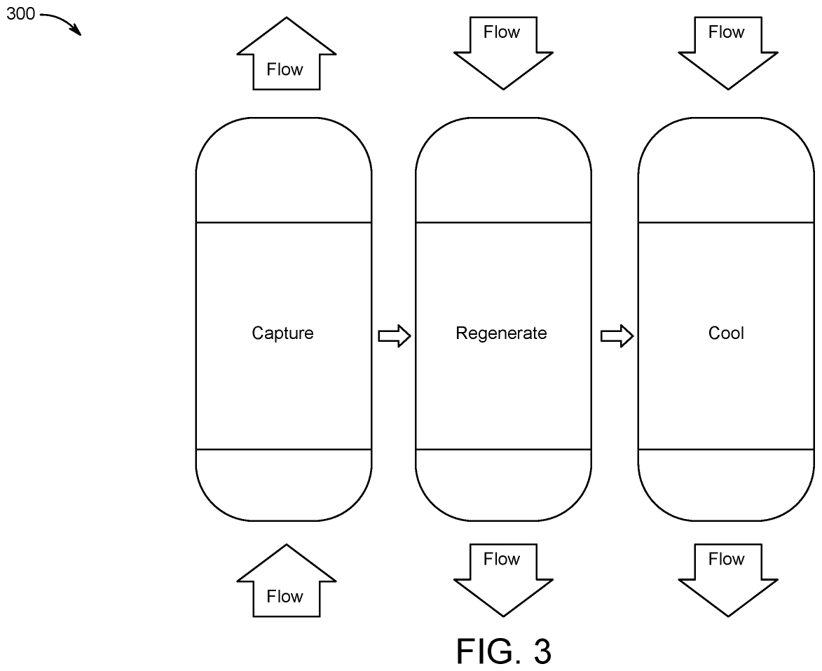

FIG. 3 shows an example diagram 300 showing flow directions of fluid flow and a process sequence in a capture vessel (e.g., capture vessel TS3). The directions of fluid flow correspond to directions in FIG. 1, where an upward flow corresponds to a flow from a bottom of the capture vessel to a top of the capture vessel (e.g., away from valves T3X, T4X, and T5X), and downward flow corresponds to a flow from the top of the capture vessel to the bottom of the capture vessel (e.g., toward valves T3X, T4X, and T5X).

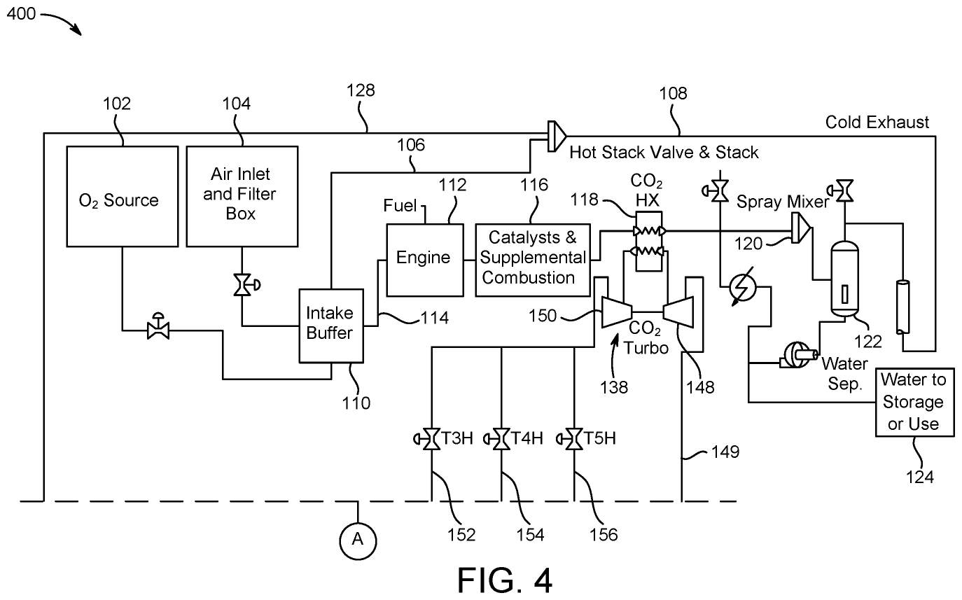

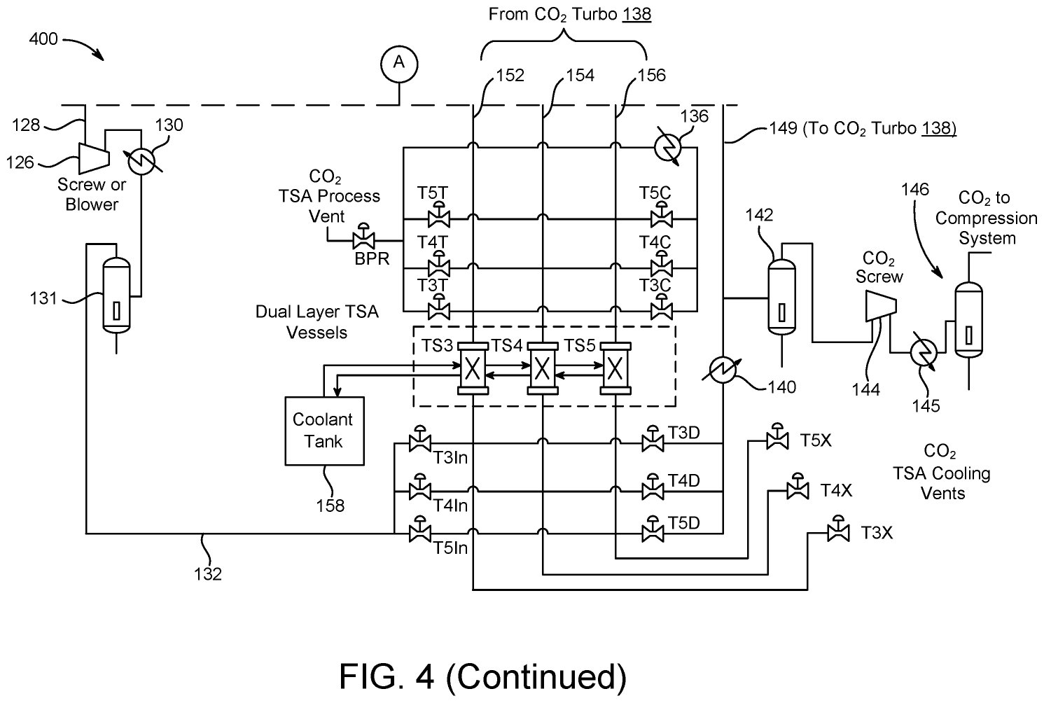

FIG. 4 illustrates a carbon capture system 400 according to one or more implementations. The carbon capture system 400 is similar to the carbon capture system 100 described in connection with FIG. 1, with the exception that the capture vessels TS3, TS4, and TS5 are used for both adsorbing water for dehydration and for adsorbing (capturing) CO₂. Thus, the capture vessels TS3, TS4, and TS5 additionally perform the water dehydration process carried out by the adsorbent vessels TSA1 and TSA2 described in connection with FIG. 1.

FIG. 5 shows a cross-section of a capture vessel 500 according to one or more embodiments. For example, the capture vessel 500 may be used for CO₂ adsorption during a CO₂-TSA process. In other words, the capture vessel 500 may correspond to any one of the capture vessels TS3, TS4, and TS5 described in connection with FIG. 1.

The top-down, the capture vessel 500 includes an upper flange 502, an upper perforated baffle 504, an upper guard 506 of dehydrating media, an upper capture media 508 (e.g., an upper bed), an inter-exchanger 510, a lower capture media 512 (e.g., a lower bed), a lower guard 514 of dehydrating media, a media support screen 516, a lower perforated baffle 518, and a lower flange 520. Thus, the inter-exchanger 510 is arranged between and in thermal contact with the upper capture media 508 and the lower capture media 512. The inter-exchanger 510 is configured to reduce temperature in the upper capture media 508 and/or the lower capture media 512 during CO₂ adsorption and is configured to aid in cooling during CO₂ adsorption. In some implementations, the inter-exchanger 510 may be enabled during the cooling stage. For example, the inter-exchanger 510 may be used to circulate the coolant in the capture vessel during the cooling stage to aid in cooling of the media.

For example, the upper guard 506 and the lower guard 514 include dehydrating media that has an affinity for water. The exhaust gas from the adsorption inlet 132 may flow into the capture vessel 500 via the upper flange 502 or via the lower flange 520. The upper guard 506 or the lower guard 514 that initially receives the exhaust gas from the adsorption inlet 132 removes water from the exhaust gas to dehydrate the exhaust gas going to the upper capture media 508 and/or the lower capture media 512. Assuming the lower guard 514 initially receives the exhaust gas from the adsorption inlet 132, the lower capture media 512 will start to capture CO₂ before the upper capture media 508 starts to capture CO₂. Prior to adsorption the capture vessel 500 is cooled during the cooling stage to increase a capture capacity of the upper capture media 508 and the lower capture media 512. However, adsorption of CO₂ causes the capture media 508 and 512 to release heat, causing a temperature of the capture media to rise. Since the lower capture media 512 will start to capture CO₂ first and start to release heat, the heat released as a result of the CO₂ adsorption at the lower capture media 512 may flow toward the upper capture media 508 and lower the capture capacity of the upper capture media 508 due to an increase in temperature at the upper capture media 508. This thermal wave associated with a heat of CO₂ adsorption can decrease a capture efficiency of a CO₂ capture system. For example, higher temperatures cause a capture efficiency of a capture media to decrease. High enough temperatures (e.g., temperatures exceeding a temperature threshold) may render a capture media inert for CO₂ capture.

The inter-exchanger 510 may include at least one coil 522 or exchanger bundle configured to carry a coolant. For example, the coil 522 may circulate the coolant through the inter-exchanger 510 to absorb or otherwise take away heat generated in the lower capture media 512 and/or the upper capture media 508 during CO₂ adsorption. The coolant may be a cool fluid (e.g., a cool gas, liquid, or fluid mixture) that flows from in inlet to an outlet of the inter-exchanger 510 to carry heat out of the capture vessel 500 during the adsorption stage. In other words, the coolant may be injected into the inter-exchanger 510 when it is desired to lower a temperature of the lower capture media 512 and/or the upper capture media 508. The coil 522 is configured to maintain separation of the coolant from the capture media such that the coolant does not physically interact with the capture media or the exhaust gas flowing through the capture vessel 500. In some implementations, the coil 522 is embedded in the capture media such that the lower capture media 512 and the upper capture media 508 are not physically separated from each other. Instead, the capture media may be filled around the coil 522.

The inter-exchanger 510 may be arranged to provide contact between individual bed media pellets and a heat transfer surface of the coil 522. The coil 522 of the inter-exchanger 510 may be made of stainless steel or another lightweight alloy construction, consistent with temperature excursions of the regeneration process. The inter-exchanger 510 may maintain temperatures in the lower capture media 512 and/or the upper capture media 508 below 150° F., which may be a temperature at which the capture capacity of the capture media is significantly reduced, made substantially inefficient, and/or made inert or substantially inert.

Even a small reduction in the temperature of the lower capture media 512 and/or the upper capture media 508, which is achievable by cooling the exhaust gas flowing through the capture vessel 500 via the inter-exchanger, may significantly increase the capture capacity of the capture vessel 500. Thus, the inter-exchanger 510, distributed internally within the capture vessel 500, is configured to manage the thermal wave associated with the heat of adsorption by lowering the temperature of the lower capture media 512 and/or the upper capture media 508 to increase the capture capacity of the capture vessel 500 during the adsorption stage.

The inter-exchanger 510 may assist in significantly reducing a carbon footprint of a gas turbine engine or a piston engine as a result of achieving a high CO₂ capture percentage, generally greater than 95%. Greenhouse gases include CO₂, NOₓ, and SOₓ that make part of acid rain and/or attack the ozone layer, as well as unburnt hydrocarbon HC (e.g., methane and non-methane), and any partial products of combustion, like aldehydes. Carbon monoxide, while not commonly considered a greenhouse gas, is a regulated pollutant that converts in the atmosphere quickly to form CO₂.

Other capture techniques, like conventional amine, do not address most of these gases. Other mole sieve capture techniques could address these gases, but gases like NOx will go into a capture vessel, but will not come out (in a pressure swing adsorption (PSA) process or a vacuum pressure swing adsorption (VPSA) process) resulting in reduced capture vessel (bed) performance over time. The CO₂-TSA described herein has a capability to also capture CO, HC, NOx with proper media choice, but, if those gases are captured, they must be tolerable as contaminants in the CO₂. CO and HC are allowed, but frequently NOₓ and SOₓ are not allowed at high concentration, since they could combine with other gases and create a corrosive mixture.

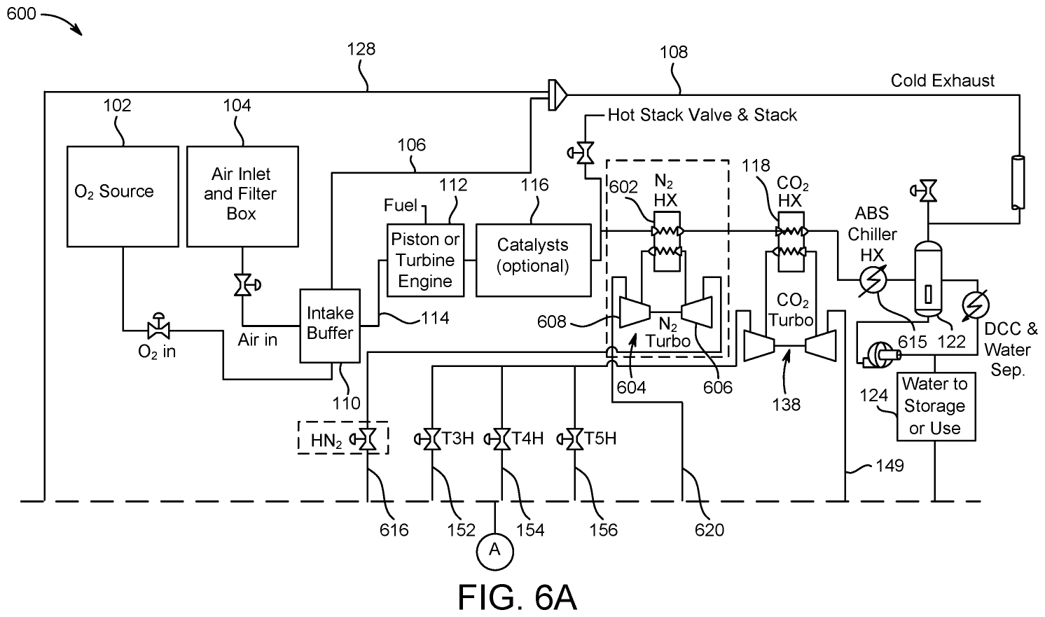

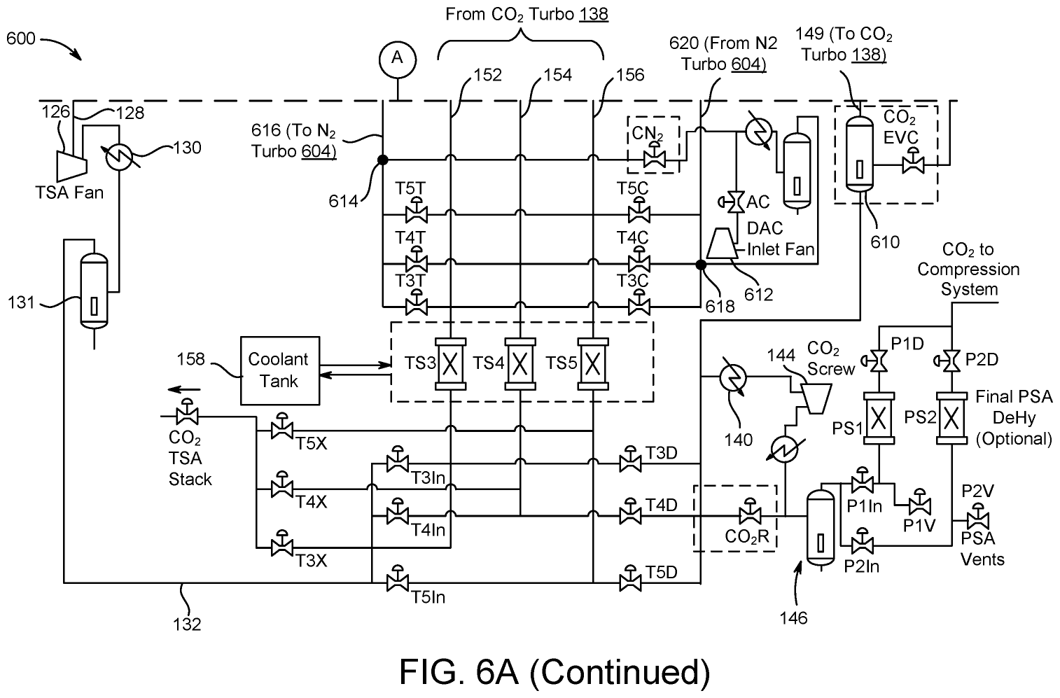

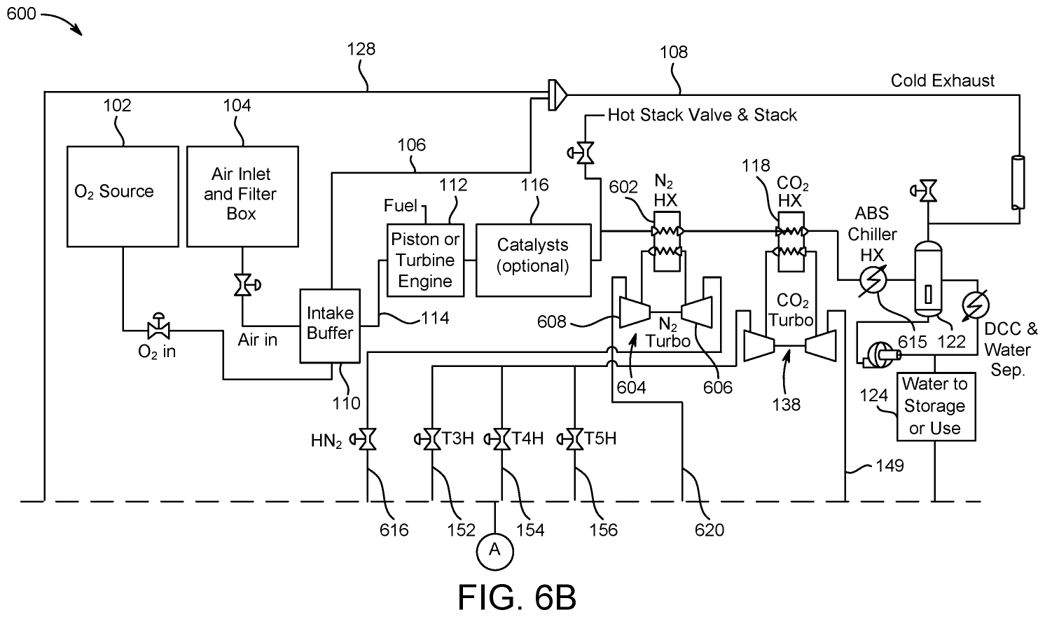

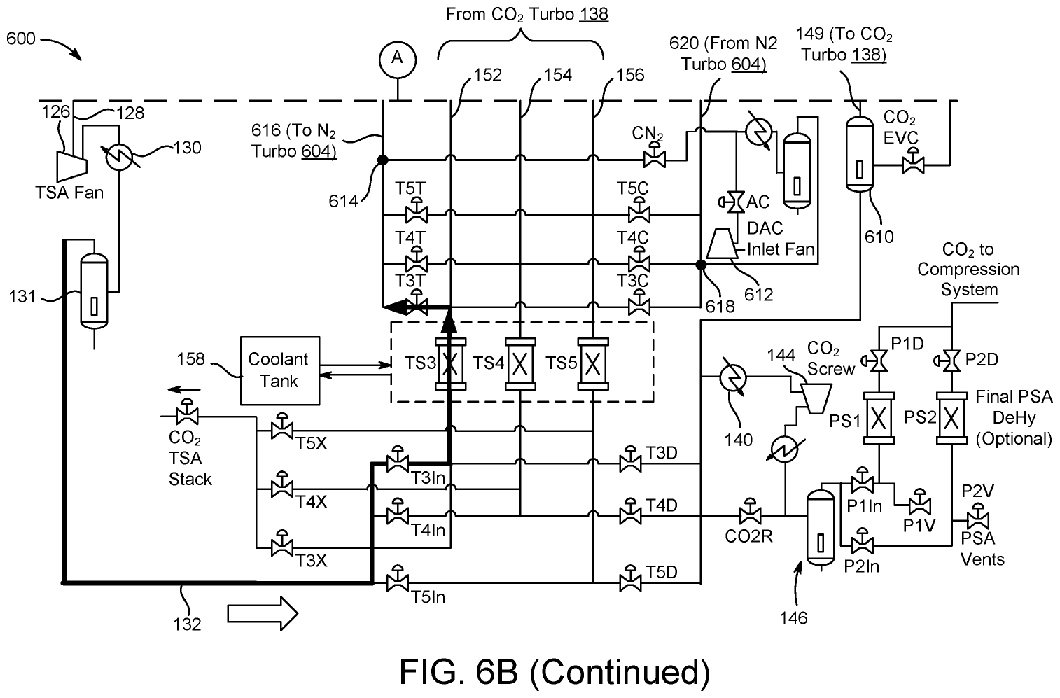

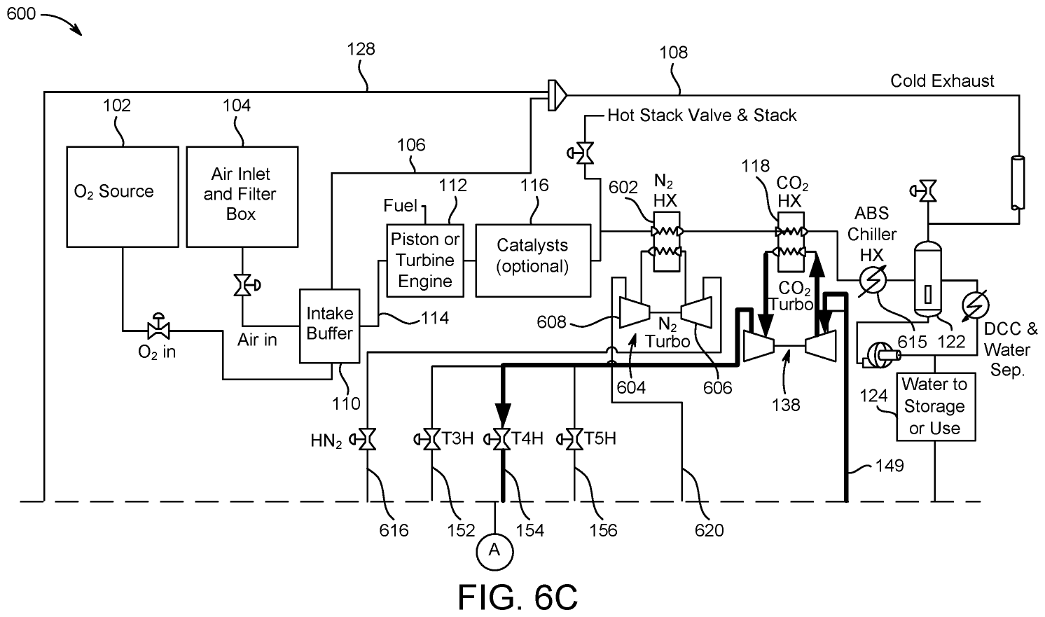

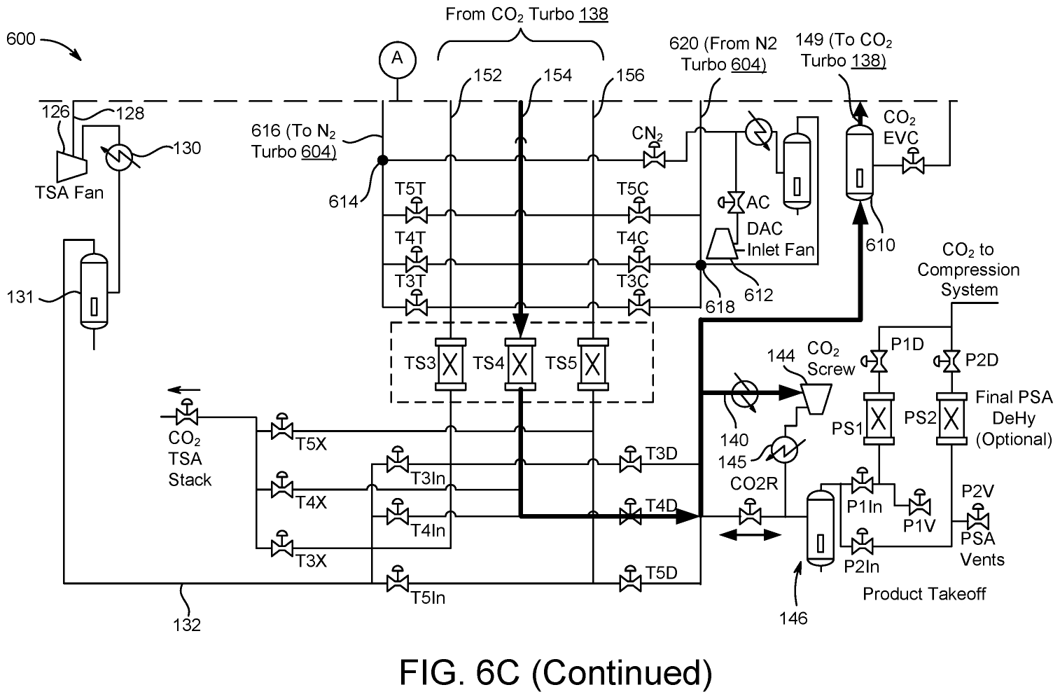

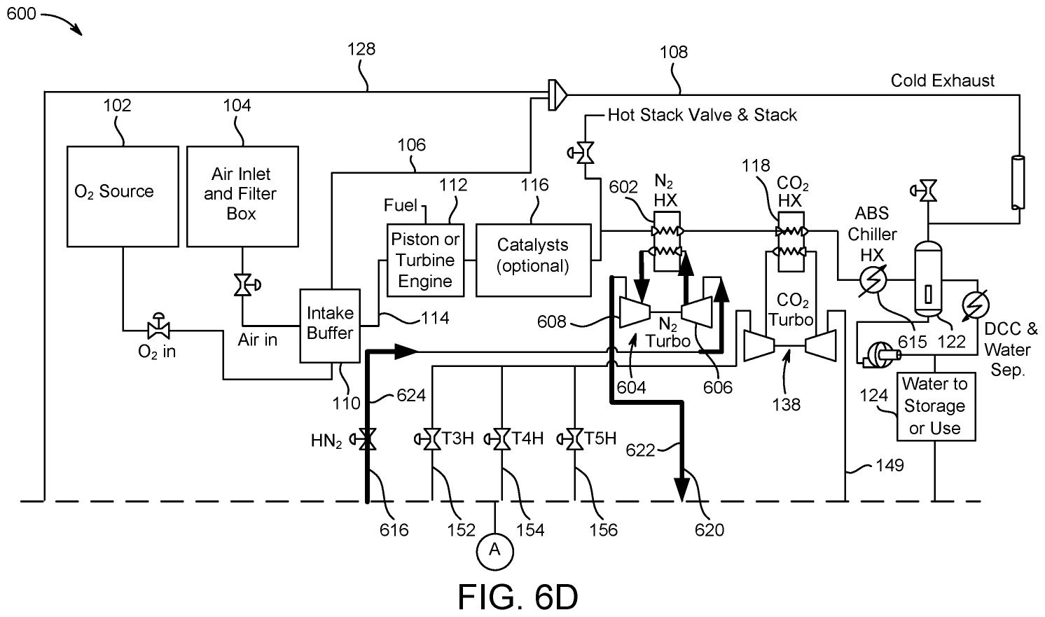

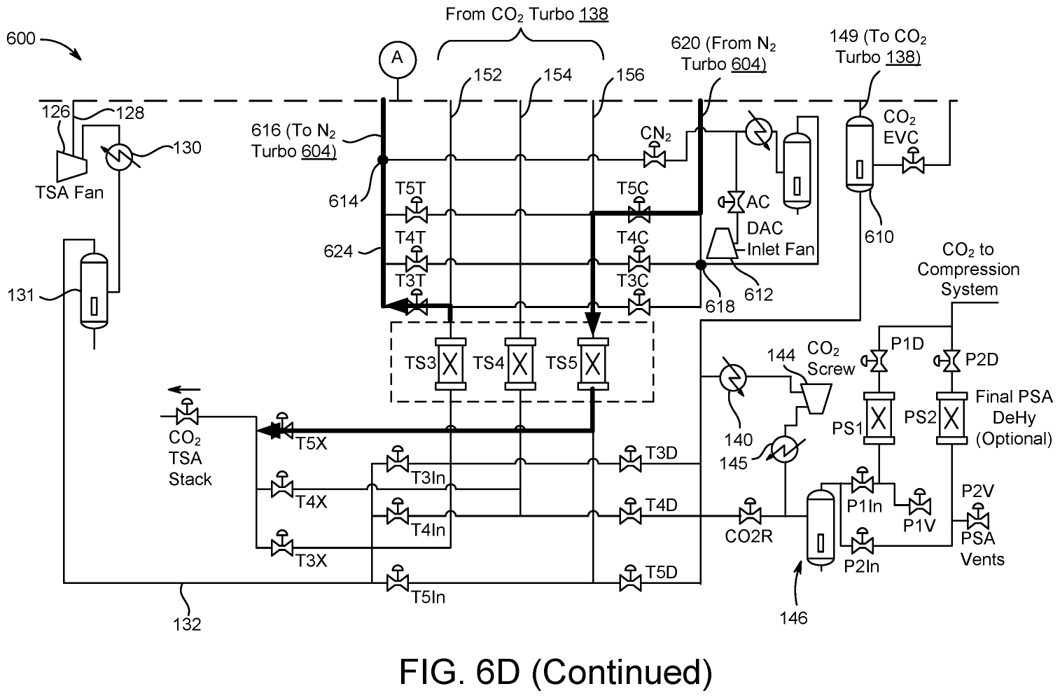

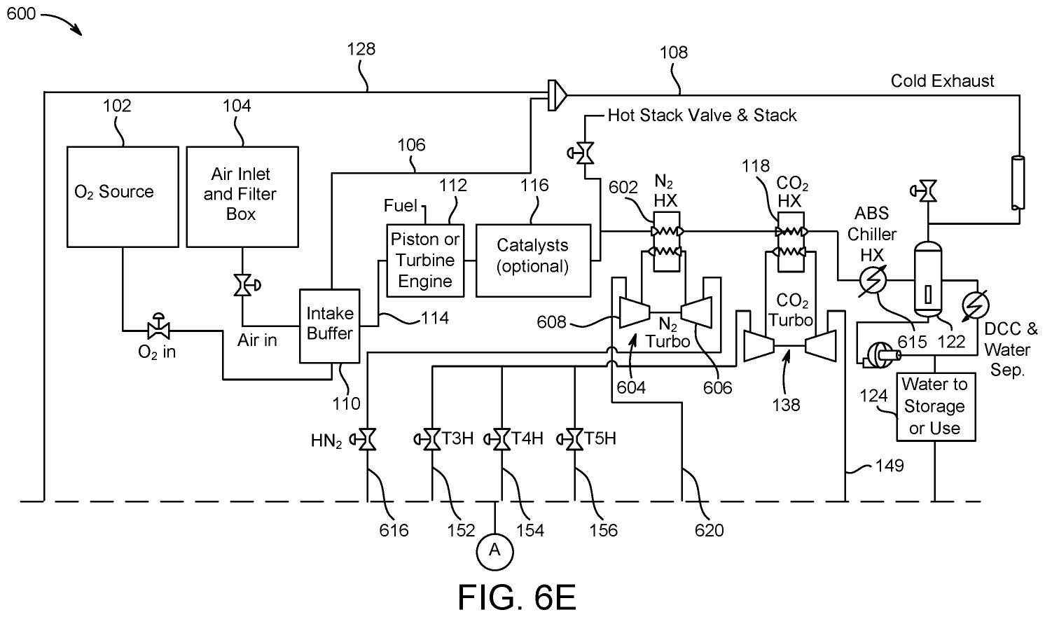

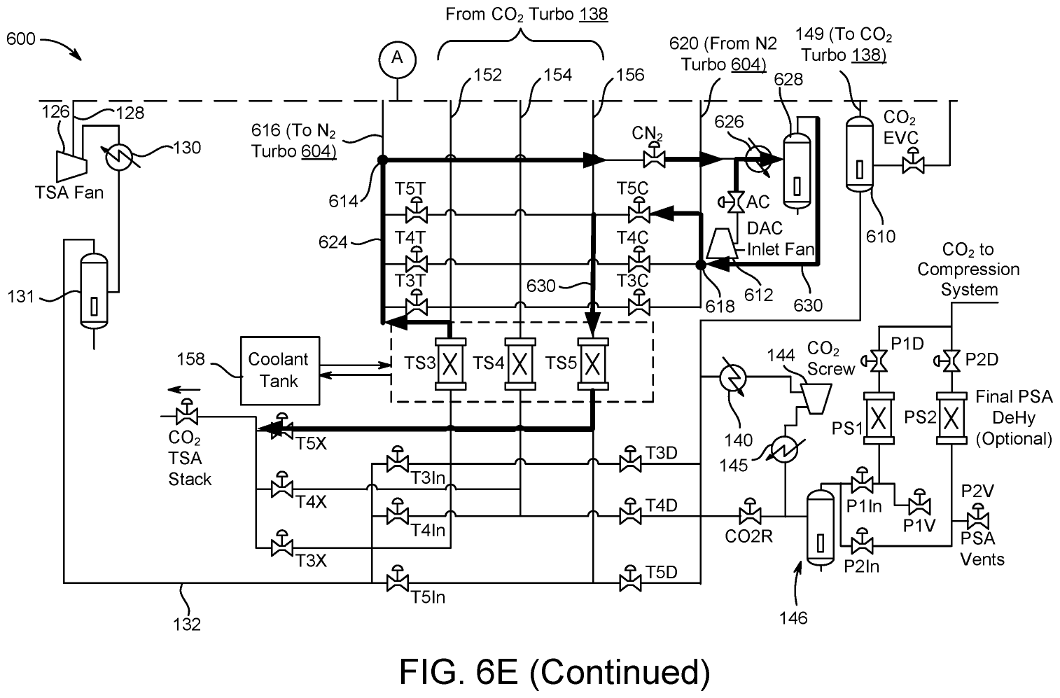

FIG. 6A illustrates a carbon capture system 600 according to one or more implementations. FIG. 6B illustrates a fluid flow path used during a CO₂ adsorption stage of a CO₂-TSA process in the carbon capture system 600 and is similar to the CO₂ adsorption stage described in connection with FIG. 1. FIG. 6C illustrates a fluid flow path used during a regeneration stage of the CO₂-TSA process in the carbon capture system 600. FIG. 6D illustrates a fluid flow path used during a drying stage of the CO₂-TSA process in the carbon capture system 600. FIG. 6E illustrates a fluid flow path used during a cooling stage of the CO₂-TSA process in the carbon capture system 600.

The carbon capture system 600 adds additional components and manifolds to the carbon capture system 400 described in connection with FIG. 4. For example, the carbon capture system 600 includes an N₂ heat exchanger (N₂ HX) 602, an N₂-turbocharger 604 that includes a compressor 606 and an expander 608, a valve HN2, a valve CN2, a valve CO2R, and a CO₂ evaporative cooler (CO₂ EVC) 610, a direct air capture (DAC) inlet fan 612, and a valve AC. These components may improve the performance of the carbon capture system 600 in terms of total CO₂ percentage captured, system stability (e.g., both in terms of production rate and component duty), and system powering. The compressor 606 may be arranged at an inlet of the N₂-turbocharger 604 and is coupled to adsorption outlet 614 of the capture vessels TS3, TS4, and TS5 via manifold 616. The expander 608 may be arranged at an output of the N₂-turbocharger 604 and is coupled to an inlet 618 of the capture vessels TS3, TS4, and TS5 via manifold 620.

In addition, an ABS chiller heat exchanger (HX) 615 is provided to chill the exhaust exiting the CO₂ heat exchanger (CO₂ HX) 118. The CO₂ evaporative cooler (CO₂ EVC) 610 is arranged between valves T3D, T4D, and T5D and the CO₂-turbocharger 138. In addition, optional valves P1in, P2in, P1V, P2V, P1D, P2D are added, as well as optional PSA vessels PS1 and PS2.

In the carbon capture system 600, a drying cycle (e.g., a hot drying cycle) is added after the regeneration stage and before the cooling stage of the batch sequence of the CO₂-TSA process described in connection with FIG. 1. Thus, once a capture vessel (e.g., TS3, TS4, or TS5) undergoes a regeneration process, the capture vessel undergoes a drying cycle before the capture vessel undergoes a cooling process. In addition, water may be used during the regeneration stage (e.g., a wet regeneration). In addition, a change in a regeneration flow direction may be reversed, as compared to the flow direction for regeneration shown in FIG. 3. For example, in FIG. 3, the flow direction for regeneration may be a flow from the top to the bottom of the capture vessel. In FIG. 6A, the flow direction for wet regeneration may be a flow from the bottom to the top of the capture vessel. This may be accomplished by reconfiguring a piping manifold and/or changing a state of one or more valves to achieve a desired flow direction through the capture vessel.

During operation of the carbon capture system 100 shown in FIG. 1, a temperature at a bed exit (e.g., valves T3D, T4D, or T5D), without temperature mitigation in a CO₂ recirculation loop, may vary at an inlet of the CO₂-turbocharger 138 from about 100° F. to greater than 500° F. during the regeneration process. A rate of CO₂ production may also change from a negative rate (e.g., capture vessel adsorbing CO₂ early in the regeneration process) to a very high rate, over 1.5 times an average rate, through much of the regeneration process. In addition, about 10% of the captured CO₂ may remain in the capture vessel TS3, TS4, or TS5, even after regeneration performed at greater than 600° F.

Referring to FIGS. 6A-6E, the CO₂-TSA process is a batch process. Whether using a three-stage adsorption, regeneration, and cooling process or a four-stage adsorption, regeneration, drying, and cooling process, the production of CO₂ will not be constant, but will occur only during the regeneration process, and generally only later in the regeneration process, after the relevant capture vessel TS3, TS4, or TS5 has warmed up. However, a constant flowrate of CO₂ is preferred over an uneven flowrate of CO₂. Accordingly, valve CO₂R may be provided to allow for recycling CO₂ during regeneration. The valve CO₂R may function as a pressure regulator, opening to prevent the capture vessel TS3, TS4, and TS5 from going into a high vacuum condition during an instant when a capture value switches from adsorption to regeneration, and partial pressure of CO₂ in the capture value increases dramatically.

While FIG. 6A shows a final dehydration via PSA after the capture process, it is also possible to replace the CO₂ evaporative cooler (CO₂ EVC) 610 with vessels PS1 and PS2, loaded with a ceramic like alumina, that will serve to both regulate the temperature at the inlet of the CO₂ turbo and to dehydrate the product CO₂ before returning to the CO₂ heat exchanger (CO₂ HX) 118 and the capture vessels TS3, TS4, and TS5.

### CO₂ Recycling During Regeneration

During an initial start of the regeneration stage, CO₂ is lacking in a main regeneration loop (e.g., the CO₂ recirculation loop) shown in FIG. 6C and it would take some time for enough CO₂ to be present for the CO₂-turbocharger 138 in the main regeneration loop to become effective. The CO₂ storage tank 146 may be used in a secondary regeneration loop to provide additional CO₂ (e.g., auxiliary CO₂) to the CO₂-turbocharger 138 during the initial start of the regeneration stage. For example, valve CO₂R may be opened to allow CO₂ stored in the CO₂ storage tank 146 to be injected into a main regeneration loop. After a predetermined duration, valve CO₂R may be closed. At this time, more than a sufficient amount of CO₂ is present in the main regeneration loop and a small percentage can be siphoned off from the main regeneration loop by the secondary regeneration loop at the cooler 140, and provided through the CO₂ screw compressor 144, to a chiller 145, and ultimately to the CO₂ storage tank 146 to replenish the CO₂ supply in the CO₂ storage tank 146. The replenished CO₂ supply may be used for the initial start of a next regeneration stage (e.g., regeneration of the next capture vessel) by opening the CO₂R valve.

Thus, the secondary regeneration loop includes a CO₂ source (e.g., the CO₂ storage tank 146) that may be configured to inject the auxiliary CO₂ into the CO₂ stream of the main regeneration loop during an initial time interval of the regeneration stage. Additionally, the CO₂ source may be configured to siphon off a portion of the CO₂ stream from the main regeneration loop during a remaining time interval of the regeneration stage to replenish the CO₂ supply that may be used for the initial start of a next regeneration stage (e.g., for a next capture vessel that enters into the regeneration stage).

Accordingly, valve CO₂R and the CO₂ storage tank 146 may be used to increase an amount of CO₂ in the main regeneration loop that flows into the CO₂ evaporative cooler (CO₂ EVC) 610 in order to decrease an amount of time until the CO₂-turbocharger 138 becomes effective for regeneration of a capture vessel.

### CO₂ Evaporative Cooler (CO₂ EVC) for Wet Regeneration

The CO₂ evaporative cooler (CO₂ EVC) 610 may be used during the regeneration stage to provide wet regeneration of a respective capture vessel TS3, TS4, or TS5. The CO₂ evaporative cooler (CO₂ EVC) 610 may introduce water vapor into a CO₂ stream in order to improve a CO₂ release at the respective capture vessel by displacing adsorbed CO₂ with adsorbed water vapor. Heat is created during the adsorption of the water vapor, which raises the bed temperature, and which further accelerates CO₂ release from the respective capture vessel.

In addition, the CO₂ evaporative cooler (CO₂ EVC) 610 regulates a temperature of the CO₂ flowing into the turbocharger compressor 148 by cooling the CO₂. By cooling CO₂ flowing into the inlet of the CO₂-turbocharger 138 (e.g., into the turbocharger compressor 148), a temperature variation at the inlet of the CO₂-turbocharger 138 is reduced. Furthermore, temperatures exceeding 400° at the inlet of the CO₂-turbocharger 138 may not be acceptable and may cause failure. Thus, by cooling CO₂ flowing into the inlet of the CO₂-turbocharger 138, a maximum temperature of the CO₂ flowing into the inlet of the CO₂-turbocharger 138 may be reduced to be closer to 100° (e.g., to be less than 300° F.). Thus, the CO₂ evaporative cooler (CO₂ EVC) 610 provides temperature control for the inlet of the CO₂-turbocharger 138.

The CO₂ evaporative cooler (CO₂ EVC) 610 may be a DCC. As shown in FIG. 6C, a portion of the warm CO₂ that exits a capture vessel (e.g., the capture vessel TS3) during regeneration is provided to the CO₂ evaporative cooler (CO₂ EVC) 610 as an inlet CO₂ gas. A saturated gas mixture of CO₂ and water vapor exits the CO₂ evaporative cooler (CO₂ EVC) 610 to the CO₂-turbocharger 138 for wet regeneration. The saturated gas mixture of CO₂ and water vapor has a reduced temperature relative to the warm CO₂ that exits the capture vessel.

A source of water for the CO₂ evaporative cooler (CO₂ EVC) 610, in cases where water is used for regeneration, can be condensed water from the engine exhaust stored in the water storage tank 124. When the CO₂ evaporative cooler (CO₂ EVC) 610 is operated with the water from the water storage tank 124 shut off, a temperature coming out of a capture vessel (e.g., the capture vessel TS3) may vary from 100-500° F. and is moderated based on a thermal capacity of a ceramic of the capture vessel. For a large ceramic load, approaching 50% of a mole sieve load per capture vessel, a peak temperature can be mitigated so that, even without water spray, an inlet temperature (e.g., less than 300° F.) of the CO₂-turbocharger 138 (e.g., an inlet temperature of the turbocharger compressor 148) is acceptable.

When the water from the water storage tank 124 is on continuously, the CO₂ evaporative cooler (CO₂ EVC) 610 acts as a very effective counter flow heat exchanger. Given a low temperature out of the CO₂ evaporative cooler (CO₂ EVC) 610, a percentage of water vapor in the saturated gas mixture of CO₂ and water vapor will be low. For example, at 100° F., a water vapor percentage may be under 7% by volume and under 3% by weight. Nevertheless, the water vapor is present as the saturated gas mixture of CO₂ and water vapor exits the expander 150 of the CO₂-turbocharger 138 and is provided to the capture vessel that is performing the regeneration (e.g., the wet regeneration). The CO₂-turbocharger 138 is configured to receive the saturated gas mixture of CO₂ and water vapor from the evaporative cooler (CO₂ EVC) 610, and heat the saturated gas mixture of CO₂ and water vapor using the CO₂ heat exchanger (CO₂ HX) 118 in order to provide a hot mixed stream of CO₂ and water vapor to the capture vessel that is configured in regeneration (e.g., a same capture vessel that produces the CO₂ stream that is mixed with the water vapor by the evaporative cooler (CO₂ EVC) 610).

The CO₂ evaporative cooler (CO₂ EVC) 610 can also be operated with water on only a percentage of a regeneration cycle. If the water is turned on late during regeneration, when a ceramic mass transfer media of the CO₂ evaporative cooler (CO₂ EVC) 610 is already hot, a large percentage of water vapor can be created, since a partial pressure of water vapor is 14.7 pounds per square inch absolute (PSIA) at 212° F. This water vapor and variable ability to create water vapor allows the regeneration process to be improved in two ways. First, water is adsorbed preferentially to CO₂ in the media of the capture vessel (e.g., capture vessel TS3, TS4, or TS5) performing the regeneration. As a result, water is adsorbed by the media of the capture vessel, and a higher amount of CO₂ is released (which is the objective during regeneration). Thus, the water vapor acts like a purge gas (e.g., a water vapor purge gas), but without reducing a dry purity of the CO₂ gas that exits the capture vessel. Second, during a process of water vapor adsorption by the media of the capture vessel, heat is created, at nominally 1800 BTU/lb of water vapor. This heat increases the temperature of the capture vessel, which further aids in driving out CO₂ from the capture vessel during regeneration. Thus, the water vapor purge derived from an output of the CO₂ evaporative cooler (CO₂ EVC) 610 is configured to increase a temperature associated with the wet regeneration stage. The net result is that the percentage of carbon captured during adsorption vs. released/produced during regeneration can be increased from nominally 90% (without the CO₂ evaporative cooler (CO₂ EVC) 610) to greater than 95% (with the CO₂ evaporative cooler (CO₂ EVC) 610).

### Hot Drying Using N₂-Turbocharger

As shown in FIG. 6D, the N₂ heat exchanger (N₂ HX) 602 and the N₂-turbocharger 604 are provided for the drying stage (e.g., hot drying) of the CO₂-TSA process. The N₂-turbocharger 604 is associated with the N₂ heat exchanger (N₂ HX) 602 and is configured to reduce a power duty. During the drying stage, shown in FIG. 6D, a hot dry gas 622 is created from a gas 624 (e.g., the dry N₂ gas) provided after CO₂ adsorption, which exits the capture vessel TS3, TS4, or TS5 at valve T3T, T4T, or T5T, respectively. The dry N₂ gas 624 is provided to the compressor 606 of the N₂-turbocharger 604 by opening valve HN2 and closing valve CN2. In other words, the compressor 606 is connected to the adsorption outlet 614 of the capture vessels TS3, TS4, and TS5 and is configured to receive the dry N₂ gas 624 from the capture vessel set in the CO₂ adsorption stage via manifold 616.

The dry N₂ gas 624 enters the N₂-turbocharger 604, where the compressor 606 compresses the dry N₂ gas 624 to produce compressed N₂ gas. The N₂ heat exchanger (N₂ HX) 602 uses the hot exhaust from the engine 112 to heat the compressed N₂ gas to produce heated (compressed) N₂ gas. The expander 608 of the N₂-turbocharger 604 then expands the heated N₂ gas, which results in a drop in temperature of the heated N₂ gas, but the heated N₂ gas remains sufficiently high with sufficient pressure to be used for hot drying of a respective capture vessel. The expander 608 is configured to output the hot dry gas 622 that is provided to the capture vessel that is set in the drying stage (e.g., capture vessel TS5). The hot dry gas 622 may be delivered from the expander 608 to the inlet 618 of the capture vessels TS3, TS4, and TS5 via manifold 620. The hot dry gas 622 is delivered to the capture vessel that is set in the drying stage.

Given that the exhaust temperature from the engine 112 can be near 900° F., and given the characteristics of the N₂-turbocharger 604 and the N₂ heat exchanger (N₂ HX) 602, it is possible to create a hot dry gas 622 that is mostly N₂ gas and has a temperature that is greater than 600° F. for the drying process. The drying process may be used to dry the media of the capture vessel after wet regeneration. For example, in order for a capture vessel to again be able to sufficiently adsorb CO₂, the water adsorbed during wet regeneration should be released from the capture vessel. The drying process may be used to release the water as water vapor via evaporation and moving the water vapor out of the capture vessel. Importantly, the N₂-turbocharger 604 may be driven exclusively or mostly via engine waste heat (e.g., from the hot exhaust from the engine 112). As a result, little or no mechanical or electrical power is needed to sustain the drying process.

While the N₂ heat exchanger (N₂ HX) 602 and the CO₂ heat exchanger (CO₂ HX) 118 are shown in series, in some implementations, the exhaust flow from the engine could be split. As result, the N₂ heat exchanger (N₂ HX) 602 and the CO₂ heat exchanger (CO₂ HX) 118 could be provided in parallel, resulting in both the N₂ heat exchanger (N₂ HX) 602 and the CO₂ heat exchanger (CO₂ HX) 118 providing a respective hot gas (e.g., a CO₂ turbo hot gas and an N₂ turbo hot gas) at temperatures greater than 600° F.

In some implementations, a number of capture vessels need not align with a number of stages. For example, in the carbon capture system 600, three capture vessels TS3, TS4, and TS5 are used for the four-stage adsorption, regeneration, drying, and cooling process. As one capture vessel performs adsorption during a process time slot (e.g., during a batch), a second capture vessel can perform regeneration (e.g., wet regeneration) during the same process time slot. In addition, a third capture vessel can perform both drying and cooling during the same process time slot, with dying being performed during a first portion of the process time slot and cooling performed during a second portion of the process time slot. In some implementations, four capture vessels may be provided, with each capture vessel being allocated one of the four stages during a process time slot. In some implementations, five or six capture vessels may be provided with additional In, T, C, H, D, and X valving and manifolds. In addition, two capture vessels may be used simultaneously for a process that takes longer, such as adsorption or cooling, and only a single capture vessel used for a shorter process, such as regeneration or drying.

Valves HN2 and CN2 may allow the carbon capture system 600 to deliver either hot dry gas 622 for the drying process (valve HN2 open and valve CN2 closed) or deliver a cool mixture of N₂ and air (e.g., cooled N₂ gas 630) for the cooling process (valve CN2 open and valve HN2 closed). Thus, even if the number of capture vessels is three, the four stages can be accomplished, for example, by splitting a drying time and a cooling time for a single capture vessel.

### Cooling

The cooling stage may be performed according to FIG. 1. Alternatively, the cooling stage may be performed according to FIG. 6E. In FIG. 6E, the dry N₂ gas 624 that exits the capture vessel that is set in the adsorbing stage (e.g., capture vessel TS3) is circulated through the valve CN₂, through a chiller 626 for further cooling, though a cooler tank 628 by the TSA screw/blower 126 and to one of the capture vessels TS3, TS4, or TS5. In the cooling stage, valve HN2 is closed and valve CN2 is open to redirect the dry N₂ gas 624 for cooling instead of for drying. The DAC inlet fan 612 is used to introduce outside air into the N₂ flow. Thus, cooled N₂ gas 630, that is mixed with outside air, is provided from the cooler tank 628, to the inlet 618, and passed through the capture vessel that is set in the cooling stage (e.g., capture vessel TS5) and exits though an exit valve (e.g., valve T5X).

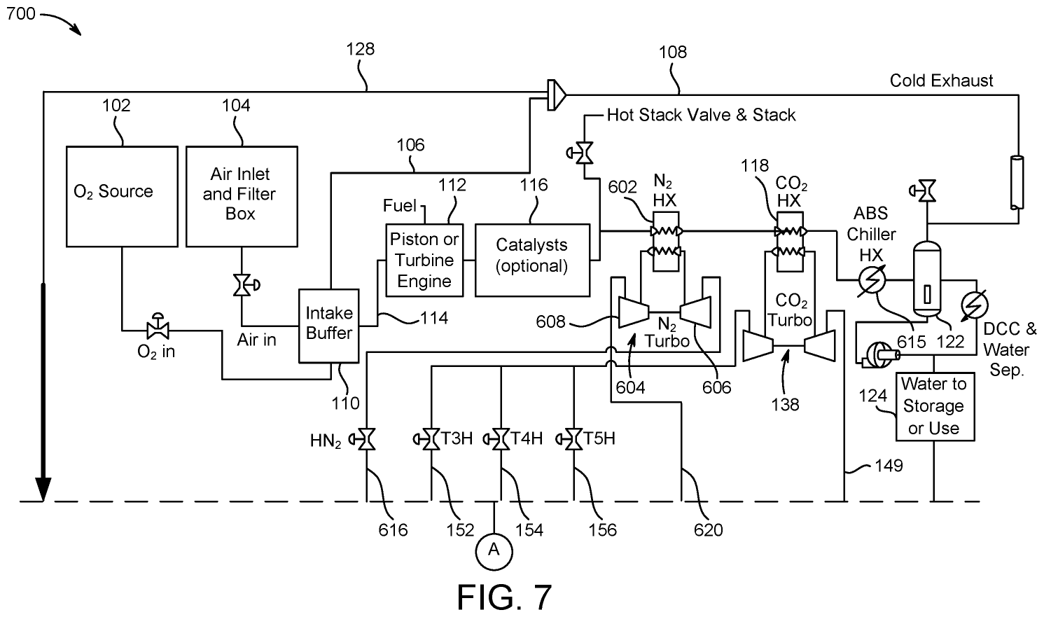

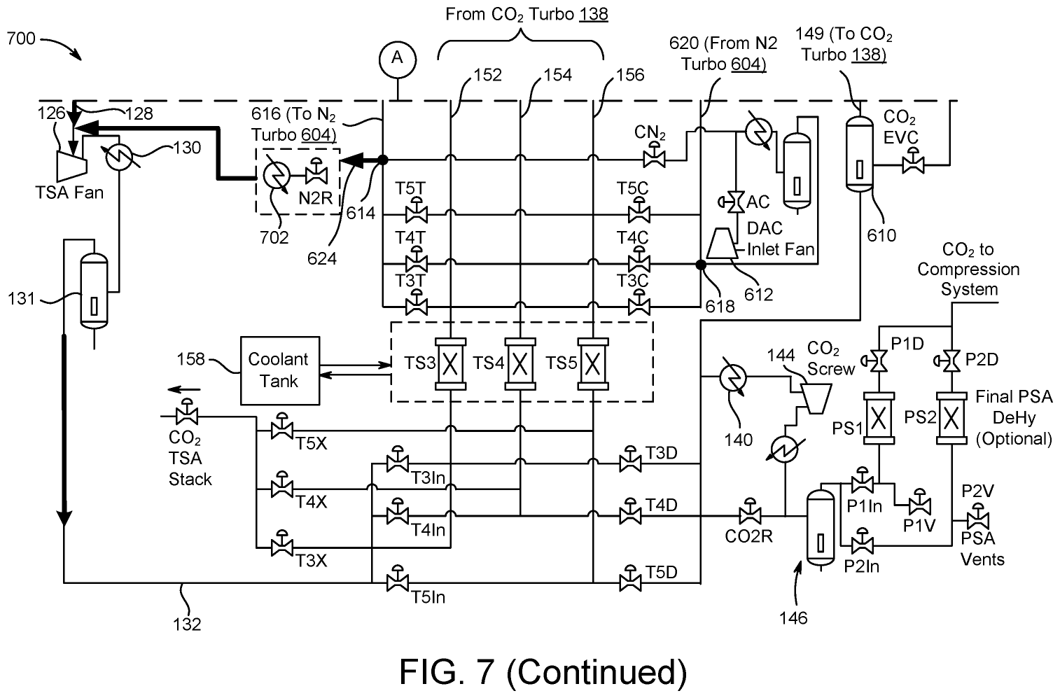

FIG. 7 illustrates a carbon capture system 700 according to one or more implementations. The carbon capture system 700 is similar to the carbon capture system 600 described in connection with FIGS. 6A-6E, with the exception that a chiller 702 (e.g., a heat exchanger) and a valve N2R (N₂ recycle) are provided between the TSA path 128 and the adsorption outlet 614 that is connected to valves T3T, T4T, T5T, HN2, CN2.

The SCC exhaust loop may be used to increase CO₂ concentration for an adsorption bed (e.g., for capture vessels TS3, TS4, and TS5) via exhaust recirculation. The SCC has the purpose of concentrating the CO₂ in the exhaust, to improve capture performance. In general, higher CO₂ concentration reduces a size of capture equipment. There are limits, and in some cases, with higher water loading and/or with higher CO₂ percentages like one might have in some reciprocating engines, a combination of heat of adsorption of water and heat of adsorption of CO₂ can result in higher than desired temperatures in a bed (e.g., in a capture vessel) during the CO₂ adsorption process. In these cases, reducing a bed temperature during adsorption will improve performance.

Valve N2R may be provided to divert some of the dry N₂ gas 624 (e.g., the depleted flue gas) generated during CO₂ adsorption from the capture vessel to the TSA screw/blower 126 in order to dilute the cold exhaust flowing into the TSA screw/blower 126 from the TSA path 128. The dry N₂ gas 624, which is substantially depleted of CO₂, is added to the cold exhaust, which results in an amount of CO₂ by volume to be decreased at the adsorption inlet 132. Thus, the dry N₂ gas 624 may be used as a diluent gas (e.g., a cold diluent gas). As a result, the cold exhaust flowing into the adsorption inlet 132 may be referred to as a diluted exhaust gas or diluted flue gas, where the amount of CO₂ has been diluted by a recycling of the dry N₂ gas 624 that is created during the adsorption stage.

For example, the dry N₂ gas may flow from the adsorption outlet 614, to the N2R valve, and may cooled by the chiller 702 to produce the cold diluent gas. The dry N₂ gas 624 may be returned to the adsorption inlet 132, artificially reducing a concentration of CO₂ to create diluted flue gas in adsorption inlet 132 and lowering a temperature of a capture vessel during CO₂ adsorption. Lowering a temperature of a capture vessel during CO₂ adsorption aids in the CO₂ adsorption.

The CO₂ concentration may be increased via exhaust gas recirculation in the SCC exhaust loop, or the CO₂ concentration may be reduced with N₂ recirculation via valve N2R. In this way, the carbon capture system 700 has the ability to get to achieve an optimum CO₂ concentration for carbon capture. For example, gas turbines may require a CO₂ concentration increase, since the gas turbines run on around 3% CO₂, while some piston engines or gas turbines with heavy supplemental firing, may require a reduction in the CO₂ concentration. The SCC exhaust loop and/or the N2 recirculation loop via value N2R may be used to control the CO₂ concentration at the capture vessels TS3, TS4, and TS5. The use of the SCC exhaust loop and/or the N2 recirculation loop is optional.

### Four-Stage Process Flow

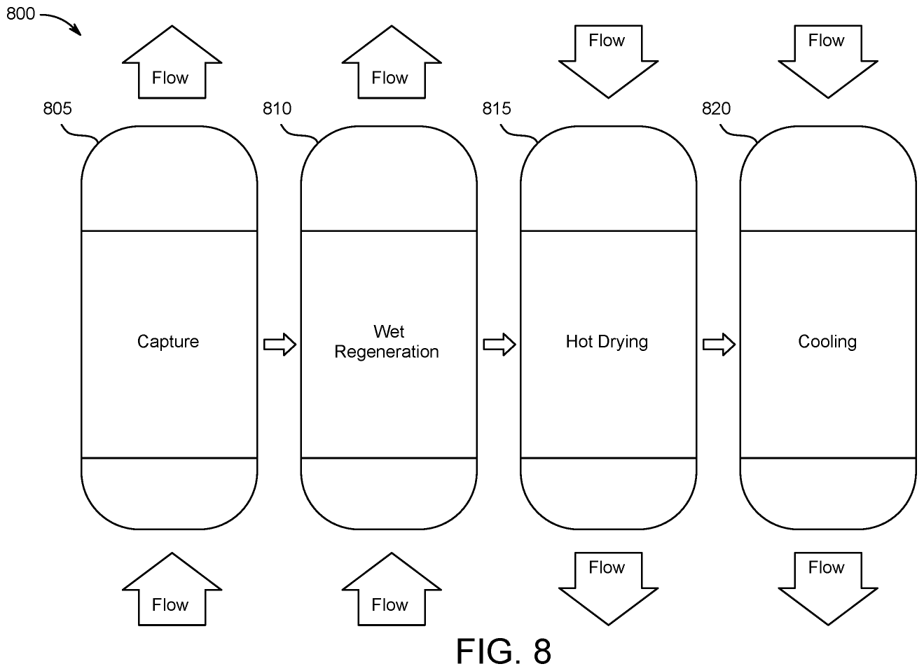

FIG. 8 shows a four-stage process flow 800 of a CO₂-TSA process in a capture vessel according to one or more implementations. The four-stage process flow 800 includes a capture stage 805 (e.g., a CO₂ adsorption stage), followed by a wet regeneration stage 810, followed by a hot drying stage 815, and followed by a cooling stage 820. The four-stage process flow 800 may be implemented by the carbon capture system 600 or the carbon capture system 700.

An addition of water vapor purge (e.g., the water vapor purge gas) via the CO₂ evaporative cooler (CO₂ EVC) 610 to the regeneration process (e.g., wet regeneration) may result in changes to the CO₂-TSA process described in connection with FIGS. 1 and 3. First, a direction of flowrate or flow in the capture vessel may be switched from top-down to bottom-up during regeneration. A change in direction flowrate to a bottom-up direction may improve regeneration because most of the water that is adsorbed into the media of the capture vessel will be adsorbed into a bottom portion of the bed, creating a hot zone at the bottom portion of the bed that heats the gas flowing to the rest of the bed. This may also make drying the bed easier.

In cases where an amount of water vapor in the water vapor purge gas is significant, a drying process may be required. For example, drying is needed for designs that provide continuous water use in the CO₂ evaporative cooler (CO₂ EVC) 610, but may also be used for designs that only use a brief purge of water vapor late in regeneration. While some drying would occur using the warm depleted exhaust gas (mostly N₂) (e.g., cooled N₂ gas 630), and some drying would even occur using air, the best drying performance will exist with use of the hot dry gas 622, as shown in FIG. 6D.

### Structure of CO₂ Evaporative Cooler (CO₂ EVC)

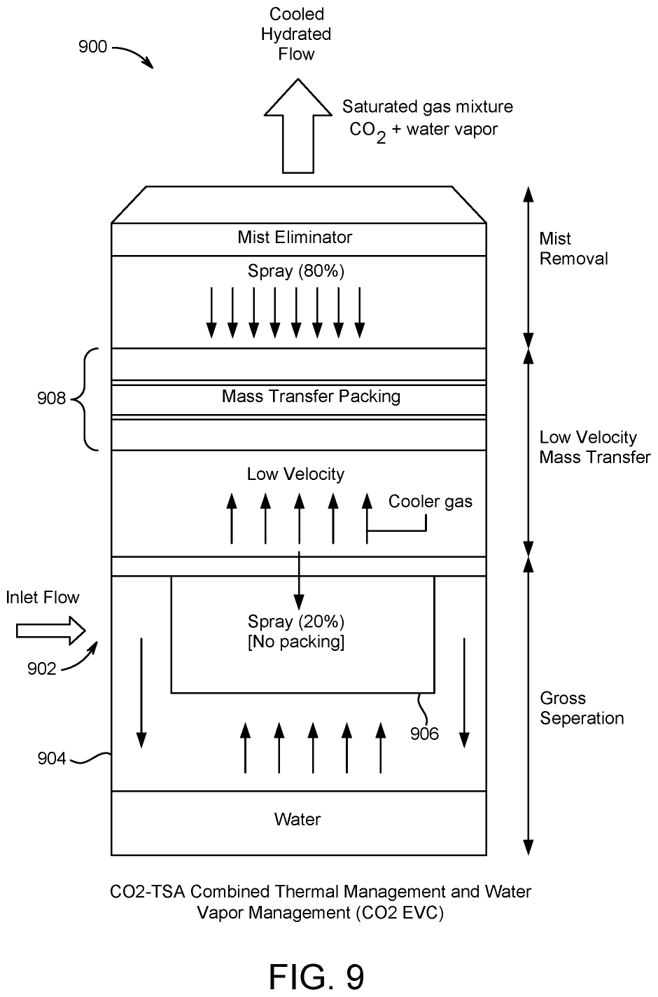

FIG. 9 shows a structure of a CO₂ evaporative cooler (CO₂ EVC) 900 according to one or more implementations. The CO₂ evaporative cooler (CO₂ EVC) 900 may correspond to the CO₂ evaporative cooler (CO₂ EVC) 610 described in connection with FIGS. 6A-6E. The CO₂ evaporative cooler (CO₂ EVC) 900 may be a direct contact cooler (DCC). Additionally, the gas-liquid separator 122, which may also be a DCC, may have a similar structure.

The CO₂ evaporative cooler (CO₂ EVC) 900 may include an inlet 902 for receiving the inlet CO₂ gas described in connection with FIG. 6C. The inlet CO₂ gas from the CO₂ regeneration flows around a skirt 904, into an area 906 where a percentage of cooling water can optionally be sprayed by water from the water storage tank 124, reducing a temperature of the inlet CO₂ gas, akin to a desuperheater. The cooler gas then flows through a mass transfer packing 908, where additional water spray above creates a counter flow effect. The mass transfer packing 908 may function as a buffer that is made of stainless steel, plastic, or ceramic (e.g., ceramic mass transfer media of ½ inch ceramic balls). As a result, a temperature of the saturated gas mixture of CO₂ and water vapor that exits from a top of the CO₂ evaporative cooler (CO₂ EVC) 900 can be quite low relative to the inlet CO₂ gas. For example, in operation, with the water spray provided at 100° F., a 600° F. CO₂ that enters the inlet 902 can be cooled to near 100° F. by the water spray at the output of the CO₂ evaporative cooler (CO₂ EVC) 900, where the saturated gas mixture of CO₂ and water vapor will leave the CO₂ evaporative cooler (CO₂ EVC) 900.

As indicated above, FIG. 9 is provided as an example. Other examples may differ from what is described with regard to FIG. 9.

### INDUSTRIAL APPLICABILITY

The described implementations significantly reduce the carbon footprint of gas turbine and piston engine operations as a result of achieving a high CO₂ capture percentage, generally greater than 95%, with the combination of techniques disclosed herein.

The greenhouse gas problem is not just CO₂, it includes gases such as NOx and SOx that make part of acid rain and attack the ozone layer, as well as unburnt hydrocarbon (methane and non-methane) and any partial products of combustion, like aldehydes. Carbon monoxide, while not commonly considered a greenhouse gas, is a regulated pollutant that converts in the atmosphere quickly to form CO₂, and thus must also be addressed.

Other capture techniques, like conventional amine, do not address most of these gases. Other mole sieve capture techniques could address these gases, but gases like NOx will go into the bed, but will not come out (in a PSA or VPSA process) resulting in reduced bed performance over time. The CO₂-TSA processes described herein have a capability to also capture CO, HC, NOx with an appropriate media choice. However, if CO, HC, NOx gases are captured, CO, HC, NOx must be tolerable as contaminants in the CO₂. CO and HC are allowed, but frequently NOₓ and SOₓ are not allowed at high concentration, since they could combine with other gases and create a corrosive mixture.

In FIGS. 6A-6E, catalysts in the optional catalysts and supplemental combustion (block 116) may be optionally used after the engine 112. Catalysts at block 116 and a DCC (e.g., gas-liquid separator 122) may be used to capture NOx and SOx upstream of the capture vessels TS3, TS4, and TS5. In particular, oxidation catalysts, which would convert CO to CO₂, and HC to CO₂ and H₂O, are low cost and may be implemented. A selective catalytic reduction (SCR) process may be used for NOx control, usually using urea or ammonia to reduce the NOx. As part of SCR implementation, often oxidation catalysts are used to convert NO gas (typically 85% of engine NOx output) to NO₂ gas. A larger oxidation catalyst would enable a larger conversion percentage of NO gas to NO₂ gas, as well as conversion from SO₂ to SO₃. In exhausts, these conversions are unimportant, unless they are pre-requisites to good SCR operation, but in the instance of this disclosure, and of the SCC in general, the exhaust is water washed in the gas-liquid separator 122 (e.g., DCC), which may have a similar construction to the CO₂ evaporative cooler (CO₂ EVC) 900, but may use a non-ceramic high void area mass transfer packing (e.g., stainless steel or plastic). An artifact of the SCC process is exhaust scrubbing, resulting in NOx that would normally be emitted as a gas being scrubbed out into the condensate. The amount of NOx reduction, pre-capture, will be a function of the conversion efficiency of NO to NO₂ in the catalyst, but conversion efficiencies of over 90% are possible, resulting in about a 10 times reduction in NOx into the capture system, and NOx release into the atmosphere, or into the CO₂ product in lieu of release into the atmosphere.

The net result of the carbon capture systems and methods described herein to the CO₂-TSA process is a reduction in CO₂ emissions, which could exceed 95%, not including the CO₂ captured from air as part of the cooling process, and reductions in other engine emissions by up to a factor of 10.

A use of activated carbon vs. a conventional mole sieve will reduce the heat of adsorption related to water and can also limit the number of pollutants captured in cases where the CO₂ purity requirements are not tolerant of the level of pollutants. Activated carbon can be used as a substitute for mole sieve, or as a blend with mole sieve within the present disclosure. In other words, activated carbon may be used in the capture vessel TS3, TS4, and TS5, and/or in a vessel of the CO₂ evaporative cooler (CO₂ EVC) 610. In some implementations, the carbon capture system 600 may be designed without a mole sieve.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A carbon capture system for carbon dioxide (CO₂)-thermal swing adsorption (TSA), the carbon capture system comprising:
an exhaust source configured to produce a hot exhaust;
an adsorption inlet arranged downstream from the exhaust source and configured to receive a cold exhaust comprising a mixture of CO₂ and nitrogen (N₂), wherein the cold exhaust is derived from the hot exhaust using one or more first heat exchangers; and
a plurality of capture vessels that are configured to be respectively cycled through a plurality of stages of a CO₂-TSA process, including a CO₂ capture stage, a regeneration stage, and a cooling stage, wherein the plurality of capture vessels are respectively coupled to the adsorption inlet for receiving the cold exhaust during the CO₂ capture stage,
wherein each capture vessel of the plurality of capture vessels includes a respective inter-exchanger, and
wherein each respective inter-exchanger is configured to circulate a respective coolant within a respective capture vessel during a respective CO₂ capture stage of the respective capture vessel in order to cool at least a portion of capture media of the respective capture vessel during the respective CO₂ capture stage.

2. The carbon capture system of claim 1, wherein the capture media of the respective capture vessel are configured to, during the respective CO₂ capture stage, receive the cold exhaust and adsorb CO2 from the cold exhaust to produce an N₂ gas.

3. The carbon capture system of claim 1, wherein each respective inter-exchanger is thermally coupled to the capture media of the respective capture vessel, and
wherein each respective inter-exchanger is configured to, during the respective CO₂ capture stage, circulate the respective coolant within the respective capture vessel to regulate a temperature of the capture media of the respective capture vessel.

4. The carbon capture system of claim 3, wherein each respective inter-exchanger is a heat exchanger arranged in the capture media of the respective capture vessel.

5. The carbon capture system of claim 3, wherein each respective inter-exchanger includes at least one coil that is configured to, during the CO₂ capture stage, carry the respective coolant such that the respective coolant absorbs heat from the capture media of the respective capture vessel and carries the heat away from the respective capture vessel.

6. The carbon capture system of claim 5, wherein the respective coolant does not make physical contact with the cold exhaust during the respective CO₂ capture stage.

7. The carbon capture system of claim 1, wherein each respective inter-exchanger is configured to circulate the respective coolant within the respective capture vessel during a respective cooling stage of the respective capture vessel in order to cool at least a portion of capture media of the respective capture vessel during the respective cooling stage.

8. A capture vessel configured to capture carbon dioxide (CO₂) according to a thermal swing adsorption (TSA) process, wherein the TSA process includes a cyclical sequence including a CO₂ capture stage, a regeneration stage, and a cooling stage, the capture vessel comprising:
capture media arranged inside the capture vessel; and
an inter-exchanger arranged inside the capture vessel and thermally coupled to the capture media, and
wherein the capture media are configured to adsorb CO₂ from an exhaust gas during the CO₂ capture stage to produce a nitrogen (N₂) gas that exits the capture vessel,
wherein the inter-exchanger is configured to, during the CO₂ capture stage, circulate a coolant within the capture vessel to regulate a temperature of the capture media.

9. The capture vessel of claim 8, wherein the inter-exchanger is configured to cool at least a portion of capture media during the CO₂ capture stage in order to increase a CO₂ adsorption capacity of the capture media.

10. The capture vessel of claim 8, wherein the inter-exchanger is a heat exchanger arranged in the capture media.

11. The capture vessel of claim 8, wherein the inter-exchanger includes at least one coil that is configured to, during the CO₂ capture stage, carry the coolant such that the coolant absorbs heat from the capture media and carries the heat out of the capture vessel.

12. The capture vessel of claim 8, wherein the coolant does not make physical contact with the exhaust gas during the CO₂ capture stage.

13. The capture vessel of claim 8, wherein the capture media comprises:
a first portion of capture media arranged proximate to an inlet of the capture vessel, wherein the inlet is configured to receive the exhaust gas; and
a second portion of capture media arranged proximate to an outlet of the capture vessel, wherein the outlet is configured to output the N₂ gas,
wherein the inter-exchanger is arranged between the first portion of capture media and the second portion of capture media, and
wherein the inter-exchanger is thermally coupled to at least the first portion of capture media.

14. The capture vessel of claim 13, wherein the inter-exchanger is thermally coupled to the second portion of capture media.

15. The capture vessel of claim 8, further comprising:
dehydrating media arranged inside the capture vessel, wherein the dehydrating media are configured to adsorb water from the exhaust gas during the CO₂ capture stage.

16. The capture vessel of claim 8, wherein the capture vessel is configured to, during the regeneration stage, release adsorbed CO₂ to produce a CO₂ stream and receive a heated CO₂ stream derived from the CO₂ stream.

17. The capture vessel of claim 16, wherein the heated CO₂ stream includes water vapor, and
wherein the capture media are configured to adsorb the water vapor from the heated CO₂ stream and release the adsorbed CO₂ based on an adsorption of the water vapor.

18. The capture vessel of claim 17, wherein the TSA process includes a drying stage performed subsequent to the regeneration stage,
wherein the capture media are configured to, during the drying stage, receive a dry hot gas and release adsorbed water via evaporation caused by the dry hot gas, and
wherein the adsorbed water is adsorbed from the water vapor during the regeneration stage.

19. The capture vessel of claim 8, wherein the inter-exchanger is configured to, during the cooling stage, circulate the coolant within the capture vessel to regulate the temperature of the capture media.

20. The capture vessel of claim 8, wherein the capture media includes activated carbon.
